(19) United States
(12) Patent Application Publication
(10) Pub. No.: US 2010/0233965 A1
(43) Pub. Date: Sep. 16, 2010

(54) RADIO COMMUNICATION DEVICE AND RADIO COMMUNICATION SYSTEM

(75) Inventor: Shinya Fukuoka, Tsurugashima-shi (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/293,306

(22) PCT Filed: Mar. 19, 2007
(86) PCT No.: PCT/JP2007/055483

§ 371 Date: Oct. 15, 2008

(30) Foreign Application Priority Data
Mar. 17, 2006 (JP) 2006-073712

(51) Int. Cl. H04B 17/00

(52) U.S. Cl. 455/67.11

(57) ABSTRACT

Upon controlling a directivity based on antenna elements of antennas, a communication coverage spread is calculated at step, a communication coverage limitation value is settled based on positional information at step, and the calculated communication coverage spread and the settled communication coverage limitation value are compared with each other at step. When the calculated communication coverage spread is larger than the communication coverage limitation value, the former is controlled to become equal to or less than the latter, and when the calculated communication coverage spread is smaller than the communication coverage limitation value, the former is controlled to reach the latter or a value at least near it.

### CROSS-REFERENCE TO RELATED APPLICATION

This application is based on Japanese Patent Application No. 2006-073712 filed on Mar. 17, 2006, the contents of which is incorporated hereinto by reference.

### BACKGROUND OF THE INVENTION

1. Field of the Invention

The present invention relates to a wireless communication apparatus that controls a directivity based on multiple antenna elements, and to a wireless communication system comprising the wireless communication apparatus.

2. Description of the Related Art

Recently, negative effects due to radio waves caused by wireless equipments have frequently brought about social problems, thereby already resulting in proposal of a conventional technique such as described in JP, A, 2004-15567 from a standpoint of exemplarily avoiding malfunctions of equipments utilizing weak electric signals, such as ranging from medical equipments to measuring meters and controlling equipments in airplanes.

The prior art is configured to sense a geographic present position of a wireless communication apparatus (terminal) from time to time by position sensing means, and to compare by judgment means the sensed present position of the wireless communication apparatus with previously stored information about radio-wave restricted areas, thereby judging whether or not the apparatus has entered a radio-wave restricted area.

The wireless communication apparatus according to the conventional technique is basically assumed to be a portable terminal, and is mainly contemplated to mitigate psychological burden of a user and other people aside, thereby achieving untroubled usage. When the apparatus is judged to have entered a radio-wave restricted area by the judgment means, the apparatus is restricted in transmission power to avoid affection on other equipments, and when the apparatus is judged to have exited the restricted area, the transmission power of the apparatus is brought back to a normal level so that radio-wave restriction is invalidated.

Incidentally, frequency resources are being rapidly consumed, exemplarily under the circumstances of: recent rapid and widespread use of portable phones; technological innovation in communication schemes; further progression of mobile types, in OA equipments and office equipments; and networked environments of personal computers, utilizing wireless LAN. For example, countries in the world each independently impose a radio-wave restriction such as by laws and regulations of each country (alternatively, each smaller district, area, or another geographic situation/classification, as the ease may be), so as to keep an orderly state of radio waves in the applicable country.

According to such radio-wave restrictions exemplarily based on laws and regulations, detailed conditions are prescribed such as directivities of radio waves to be transmitted from wireless communication apparatuses, and radio interference areas, unlike the above-described conventional technique which simply judges presence or absence of a wireless communication apparatus in a predetermined area. For example, according to the provision for a 2.4 GHz band in the Radio Law in Japan, antenna gains of low-powered data communication systems (wireless LANs) are principally limited to 2.14 dBi at the maximum. Only, when areas to be subjected to radio interference are not increased, it is exceptionally possible to use an antenna having a higher directivity in a manner to extend a communication distance.

The above-described prior art is configured to simply judge presence or absence of a wireless communication apparatus in a predetermined area, thereby failing to deal with provisions of communication coverage and the like such as based on laws and regulations to be applied in the above-described countries, districts, and other geographic situations/classifications, respectively. This results in difficulty in realizing a maximum communication coverage within the limits capable of conforming to such provisions.

The above described problem is given as one of examples the present invention should solve.

### SUMMARY OF THE INVENTION

To solve the above problem, the present invention according to claim 1 provides a wireless communication apparatus comprising: an antenna unit comprising multiple antenna elements; and a directivity controlling unit that controls directivity based on the multiple antenna elements of the antenna unit; wherein the wireless communication apparatus further comprises: a spread calculation unit that calculates a spread of the communication coverage based on the antenna unit having the directivity controlled by the directivity controlling unit; a limitation setting unit that sets a communication coverage limitation value corresponding to positional information based thereon; and a comparison unit that compares the calculated communication coverage spread with the settled communication coverage limitation value; and the directivity controlling unit controls the directivity based on the multiple antenna elements of the antenna unit depending on the comparison result by the a comparison unit so that the communication coverage spread becomes equal to or less than the applicable limitation value, when the calculated communication coverage spread exceeds the settled communication coverage limitation value.

To solve the above problem, the present invention according to claim 2 provides a wireless communication apparatus comprising: an antenna unit comprising multiple antenna elements; and a directivity controlling unit that controls directivity based on the multiple antenna elements of the antenna unit; wherein the wireless communication apparatus further comprises: a spread calculation unit that calculates a spread of the communication coverage based on the antenna unit having the directivity controlled by the directivity controlling unit; a limitation setting unit that sets a communication coverage limitation value corresponding to positional information based thereon; and a comparison unit that compares the calculated communication coverage spread with the settled communication coverage limitation value; and that the directivity controlling unit controls the directivity based on the multiple antenna elements of the antenna unit depending on the comparison result by the a comparison unit so that the communication coverage spread is brought to be a value near the limitation value, when the calculated communication coverage spread is equal to or less than the settled communication coverage limitation value.

To solve the above problem, the present invention according to claim 9 provides a wireless communication system comprising a wireless transmission apparatus and a wireless receipt apparatus, and being capable of conducting communications in a multiple input multiple output scheme, wherein at least one of the wireless transmission apparatus and the wireless receipt apparatus comprises: an antenna unit comprising multiple antenna elements; a directivity controlling unit that controls directivity based on the multiple antenna elements of the antenna unit; a spread calculation unit that calculates a spread of communication coverage based on the antenna unit having the directivity controlled by the directivity controlling unit; a limitation setting unit that sets a communication coverage limitation value corresponding to the positional information based thereon; and a comparison unit that compares the calculated communication coverage spread with the settled communication coverage limitation value; and the directivity controlling unit controls the directivity based on the multiple antenna elements of the antenna unit depending on the comparison result by the a comparison unit so that the communication coverage spread becomes equal to or less than the applicable limitation value, when the calculated communication coverage spread exceeds the settled communication coverage limitation value.

To solve the above problem, the present invention according to claim 10 provides a wireless communication system comprising a wireless transmission apparatus and a wireless receipt apparatus, and being capable of conducting communications in a multiple input multiple output scheme, wherein at least one of the wireless transmission apparatus and the wireless receipt apparatus comprises: an antenna unit comprising multiple antenna elements; a directivity controlling unit that controls directivity based on the multiple antenna elements of the antenna unit; a spread calculation unit that calculates a spread of communication coverage based on the antenna unit having the directivity controlled by the directivity controlling unit; a limitation setting unit that sets a communication coverage limitation value corresponding to the positional information based thereon; and a comparison unit that compares the calculated communication coverage spread with the settled communication coverage limitation value; and that the directivity controlling unit controls the directivity based on the multiple antenna elements of the antenna unit depending on the comparison result by the a comparison unit so that the communication coverage spread is brought to be a value near the limitation value, when the calculated communication coverage spread is equal to or less than the settled communication coverage limitation value.

### BRIEF DESCRIPTION OF THE DRAWINGS

FIG. 1 is a schematic overall constitutional view of a wireless communication system provided with a wireless communication apparatus according to an embodiment of the present invention.

FIG. 2 is a perspective view of a detailed structure of an antenna shown in FIG. 1.

FIG. 3 is an explanatory view of a control system of antennas shown in FIG. 1 and FIG. 2.

FIG. 4 is a functional block diagram of a detailed configuration of the controlling apparatus shown in FIG. 1.

FIG. 5 is a functional block diagram of a detailed configuration of functions according to a transmission side of the configuration shown in FIG. 4.

FIG. 6 is a functional block diagram of a detailed configuration of functions according to a receipt side of the configuration shown in FIG. 4.

FIG. 7 is a flowchart of a controlling process to be executed by a whole controller of the apparatus shown in FIG. 1.

FIG. 8 is a schematic explanatory view of a radiowave irradiation form in a standby awaiting state after initial setting.

FIG. 9 is a flowchart of a detailed procedure at step S100.

FIG. 10 is a flowchart of a detailed procedure at each of step S120, step S125, step S135, step S140, and step S150.

FIG. 11 is a schematic explanatory view of a scheme for communicating with another wireless communication apparatus.

FIG. 12 is another schematic explanatory view of the scheme for communicating with the other wireless communication apparatus.

FIG. 13 is a conceptional explanatory view of a behavior in MIMO communications.

FIG. 14 is a schematic explanatory view of a scheme for communicating with still another wireless communication apparatus.

FIG. 15 is a schematic view of an actual application example of the wireless communication apparatus.

FIG. 16 is a schematic view of another applied example of a wireless communication apparatus.

FIG. 17 is a schematic view of an actual application example of a wireless communication apparatus configured to achieve output control together with directivity control.

FIG. 18 is an explanatory view of an exemplary effect for extending a communication distance by virtue of realization of maximum communication coverage.

FIG. 19 is an explanatory view of an image of directivity control property by a passive side controlling means and an active side controlling means.

### DETAILED DESCRIPTION OF THE PREFERRED EMBODIMENTS

The following describes an embodiment of the present invention with reference to accompanying drawings.

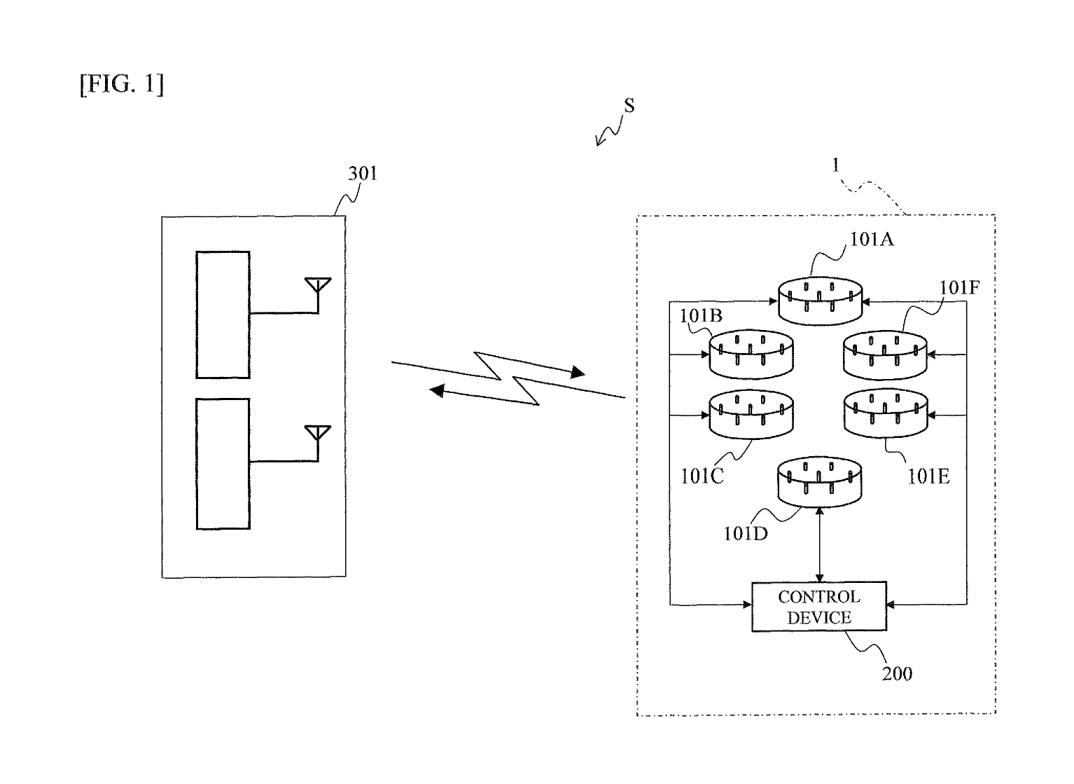

FIG. 1 is a schematic overall constitutional view of a wireless communication system provided with a wireless communication apparatus according to an embodiment of the present invention.

The wireless communication apparatus 1 of the embodiment in the wireless communication system S shown in FIG. 1 includes multiple (in this embodiment, six) antennas 101A, 101B, 101C, 101D, 101E, and 101F, and a control device 200 for controlling operations of the antennas 101A to 101F. The wireless communication apparatus 1 is configured to be capable of communications through the antennas 101A to 101F based on a multiple input and output (MIMO) scheme to be detailed later, and is configured to conduct communications with another wireless communication apparatuses 301, by means of at least one of the antennas 101A to 101F based on control by the control device 200 (in detail, whole controller 201 to be described later).

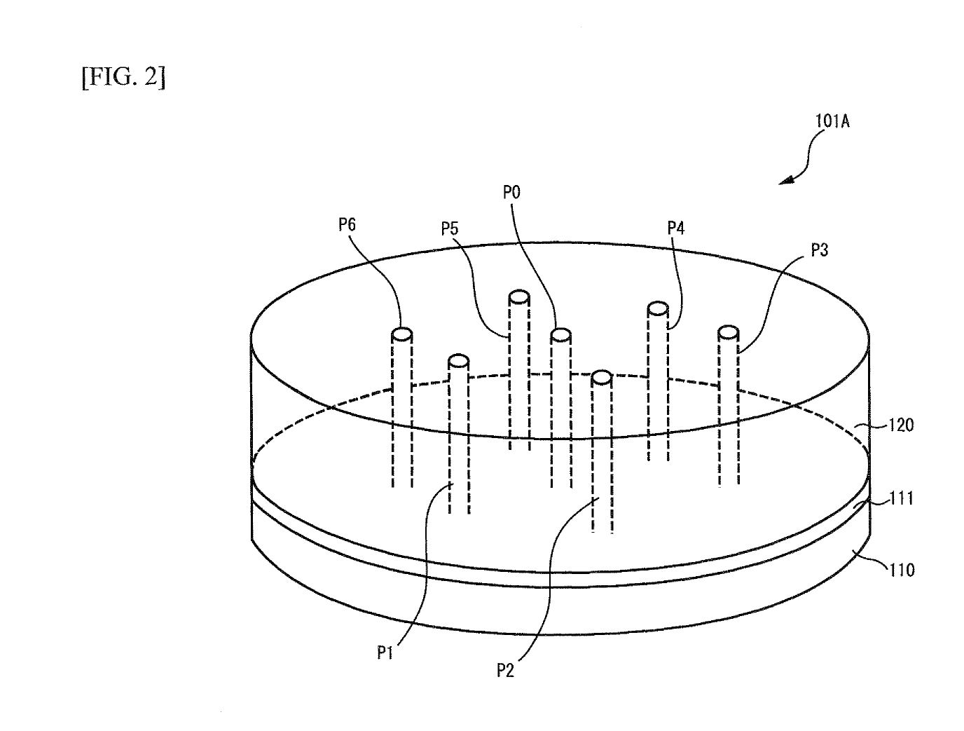

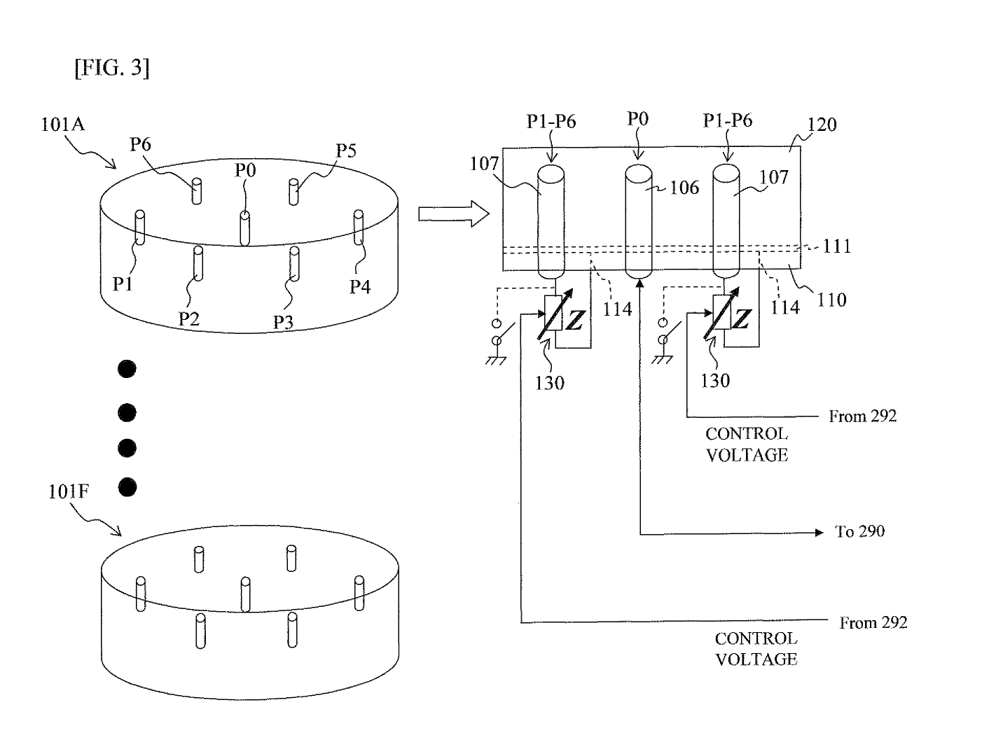

FIG. 2 is a perspective view of a detailed structure of the antenna 101A shown in FIG. 1, and FIG. 3 is an explanatory view of a control system of the antennas 101A to 101F. In FIG. 2 and FIG. 3, the antenna 101A comprises: a dielectric substrate 110 such as made of polycarbonate; an earth conductor 111 formed over substantially the whole of an upper surface of the dielectric substrate 110; a dielectric 120 formed in a substantially cylindrical shape, on the earth conductor 111; and multiple (in this embodiment, seven) antenna elements P formed (i.e., encapsulated or loaded) in a manner to be buried within the dielectric 120 and in a state electrically insulated from the earth conductor 111.

The antenna elements P each establish a monopole element having a longitudinal direction perpendicular to a plane of the earth conductor 111, and are constituted of one active antenna element P0 (active element), and at least one passive antenna element (passive element) (in this embodiment, six passive antenna elements P1 to P6).

The active antenna element P0 comprises a columnar emission element 106 electrically insulated from the earth conductor 111 and buried within the dielectric 120. The emission element 106 has one end connected with a signal line, so that wireless signals fed from the control device 200 are fed to the active element P0 via RF circuit 290 (to be described later) and emitted from the active antenna element P0.

The passive antenna elements P1 to P6 are centered around the active antenna element P0 at predetermined distances therefrom, respectively, in a substantially circular configuration in this embodiment. The passive antenna elements P1 to P6 each comprise a substantially columnar passive element 107 electrically insulated from the earth conductor 111 and disposed to vertically penetrate through the dielectric substrate 110 and dielectric 120. The passive elements 107 each have one end earthed to the earth conductor 111 in a high-frequency manner, via: variable reactive element 130 (such as made of variable capacitance diode) having a predetermined reactance value; and through-hole conductor 114 filled and formed vertically through the dielectric substrate 110.

In this state, the emission element 106 has substantially the same longitudinal length as that of each passive element 107. However, when the variable reactive elements 130 exemplarily each have an inductance characteristic (L characteristic), for example, the variable reactive elements 130 each act as an extension coil, so that the passive antenna elements P1 to P6 are each made to have an electrical length longer than that of the active antenna element P0 and thus each act as a reflector. In turn, when the variable reactive elements 130 each have a capacitance characteristic (C characteristic), for example, the variable reactive elements 130 each act as a loading capacitor, so that the passive antenna elements P1 to P6 are each made to have an electrical length shorter than that of the active antenna element P0 and thus each act as a wave director. Namely, the control voltage to be applied to the applicable variable reactive element 130 is changed to vary the reactance value of the variable reactive element 130 itself, thereby varying the electrical length of the passive antenna element P1 comprising the associated passive element 107 relative to the active antenna element P0, thereby enabling to change a horizontal plane directivity characteristic of the antenna 101A.

Note that the above has been explained taking the antenna 101A as an example, the remaining antennas 101B through 101F each have the same configuration, and the same control is conducted therefor.

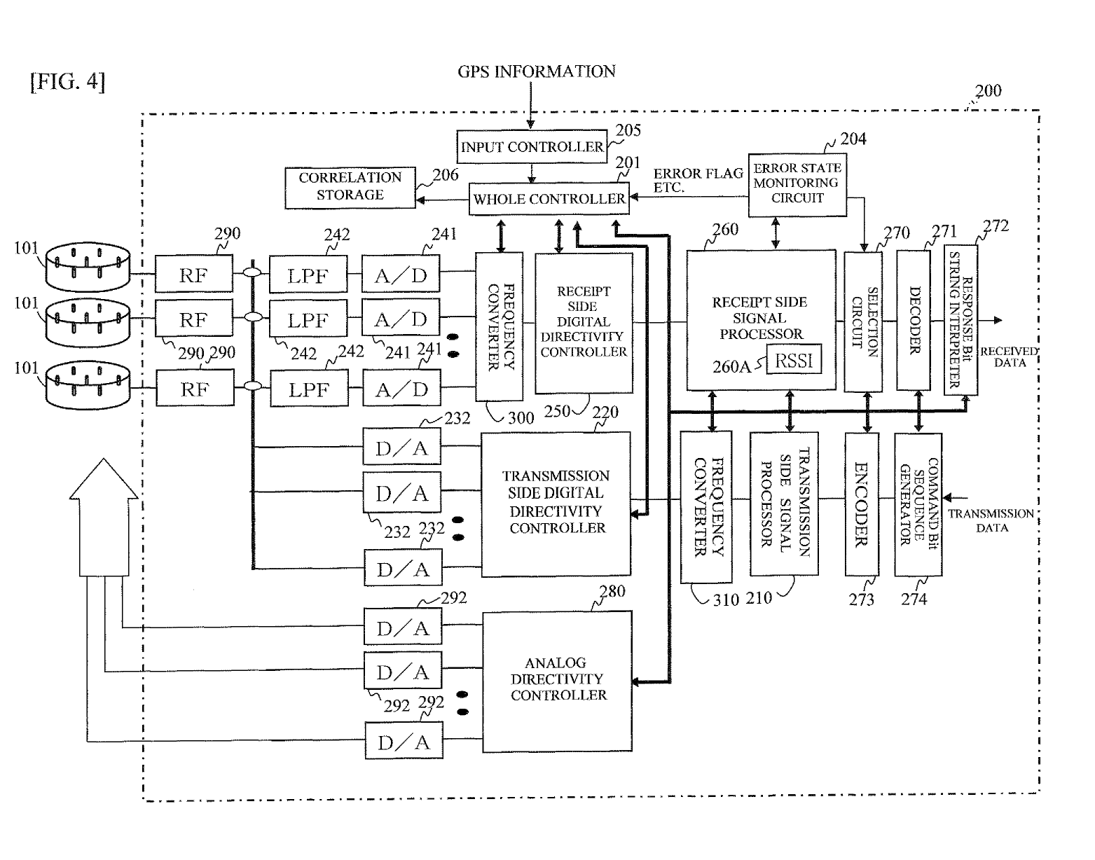

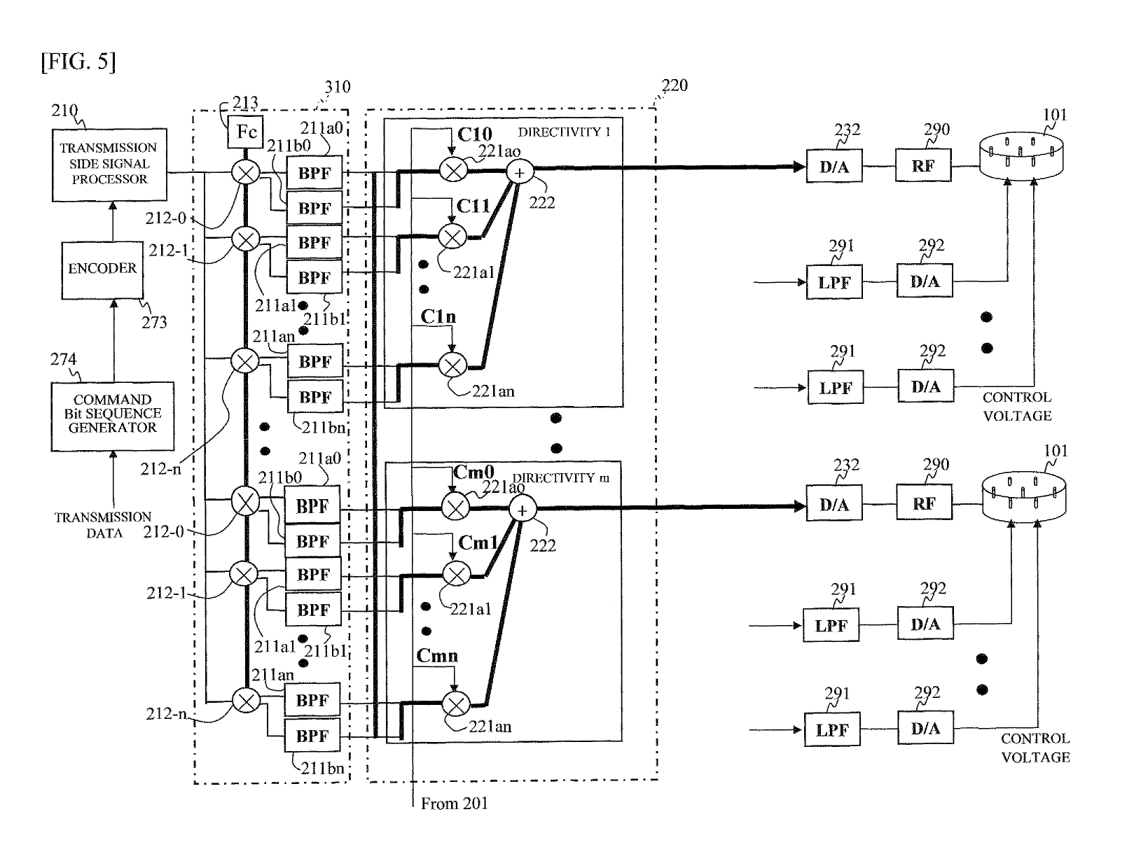

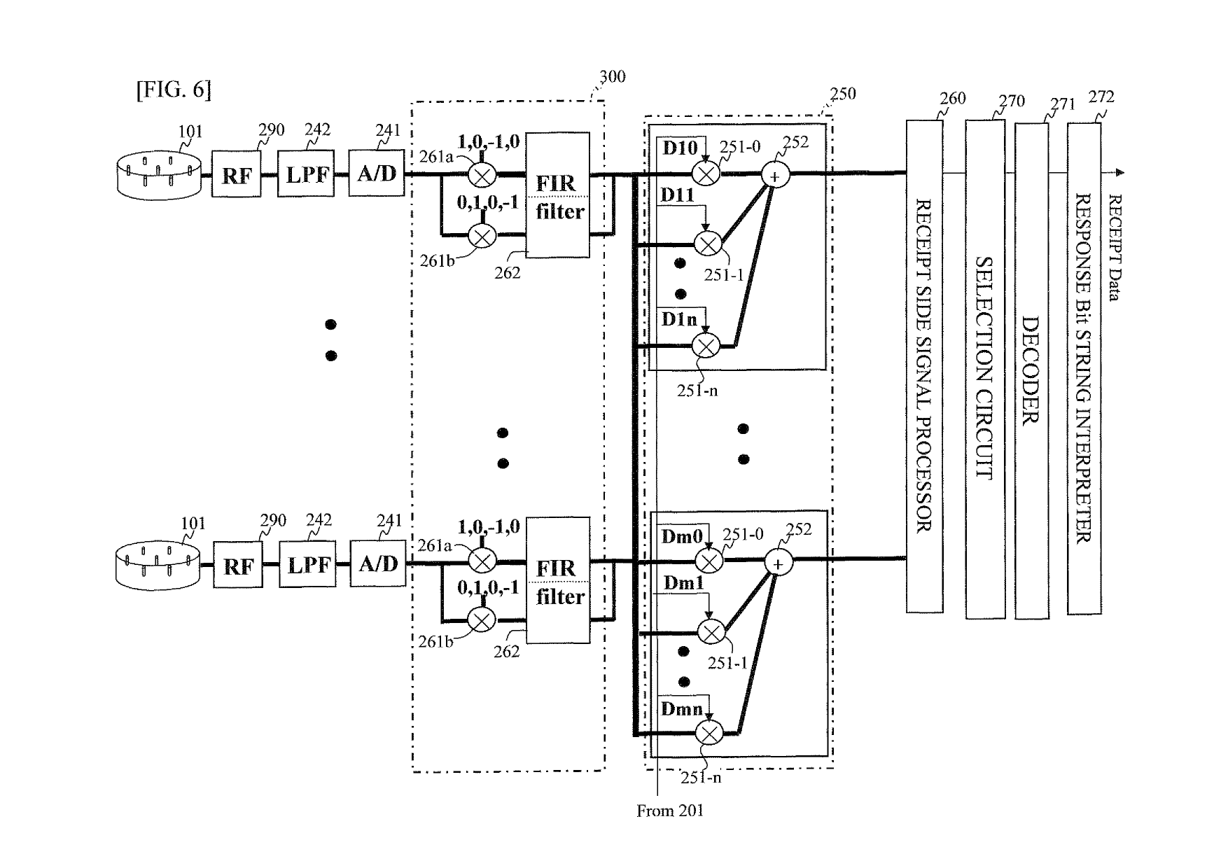

FIG. 4 is a functional block diagram of a detailed configuration of the control device 200 shown in FIG. 1, FIG. 5 is a functional block diagram of a detailed configuration of functions according to a transmission side of the configuration of FIG. 4, and FIG. 6 is a functional block diagram of a detailed configuration of functions according to a receipt side of the configuration of FIG. 4.

In FIG. 4, FIG. 5, and FIG. 6, the control device 200 includes: RF circuits 290 connected one by one to the active antenna elements P0 of the m (in this embodiment, m=6) antennas 101, respectively, in a manner common to transmission and receipt (it is possible to additionally include an IF circuit); LPFs 242 and A/D converters 241 provided in numbers of m correspondingly to received signals from the in antennas 101, respectively, and configured to achieve band limitation of the received signals and to conduct analog-to-digital conversion thereof, respectively; a frequency converter 300 configured to receive the received signals from the m A/D converters 241, and to conduct processing such as demodulation, for example; a receipt side digital directivity controller 250 (such as comprising digital filters corresponding to complex numbers having I components and Q components, respectively) configured to conduct a predetermined receipt directivity control processing for received signals demodulated by the frequency converter 300; a receipt side signal processor 260 configured to conduct a known demodulation processing such as based on an OFDM scheme or FM scheme, for signals from the receipt side digital directivity controller 250; an error state monitoring circuit 204 configured to monitor occurrence of processing errors at the receipt side signal processor 260; a selection circuit 270 configured to conduct selection from signals demodulated by the receipt side signal processor 260, depending on the monitoring result of the error state monitoring circuit 204; a decoder 271 configured to decode the signal (demodulated wave) selected by the selection circuit 270, by a predetermined known technique; and a response bit string interpreter 272 configured to interpret the signals decoded by the decoder 271, thereby reading out a receipt data (information signal) received at the antennas 101 from a communication mate.

Further, the control device 200 further includes: a command bit sequence generator 274 configured to generate a command bit sequence corresponding to a transmission data to be transmitted from the antennas 101; an encoder 273 configured to encode a digital signal outputted from the command bit sequence generator 274, in a predetermined manner; a transmission side signal processor 210 configured to be supplied with a signal encoded by the encoder 273, and to conduct a known modulation processing such as based on an OFDM scheme or FM scheme, for the signal; a frequency converter 310 configured to conduct a predetermined processing such as modulation, for signals from the transmission side signal processor 210; a transmission side digital directivity controller 220 (such as comprising digital filters corresponding to complex numbers having I components and Q components, respectively) configured to conduct a predetermined transmission directivity control processing for a signal from the frequency converter 310; D/A converters 232 provided in a number of m correspondingly to transmission signals to the m antennas 101, and configured to output signals to the RF circuits 290 after digital-to-analog conversion, respectively; an analog directivity controller 280 configured to conduct a predetermined directivity control processing by utilizing the multiple (in this embodiment, six) passive antenna elements P1 to P6 of the m (in this embodiment, m=6) antennas 101; D/A converters 292 provided in a number of m correspondingly to transmission signals to the m antennas 101, respectively, and configured to output control voltages to the passive antenna elements P1 to P6 of the antennas 101, respectively, after digital-to-analog conversion of signals from the analog directivity controller 280; a whole controller 201 configured to control the various components of the whole apparatus, including the receipt side digital directivity controller 250, transmission side digital directivity controller 220, analog directivity controller 280, and the like; an input controller 205 configured to be supplied with an input of positional information from a not shown GPS (global positioning system); and a correlation storage 206 configured to store a correlation between the positional information and an allowed communication coverage.

The frequency converter 310 comprises m routes correspondingly to the number m of antennas 101 (in the above embodiment, m=6), and a transmission digital signal output unit 213 which is provided commonly to the m routes and which is configured to output a digital signal (such as a signal obtained by sampling a sine wave) forming a transmission signal (carrier wave) Fc to a communication mate, exemplarily based on sampling values in a function table stored in a manner to correspond to respective phases at predetermined sampling points.

Further, the in routes each comprise: modulators (multipliers) 212-0, 212-1, . . . , 212-n each configured to modulate the carrier wave Fc from the transmission digital signal output unit 213 based on an information signal (data) encoded by the encoder 273 and to output the thus modulated signal as transmission information (e.g., to conduct GFSK modulation to thereby generate an I component and a Q component); and BPFs 211a0, 211b0, 211a1, 211b1, . . . 211an, and 211bn configured to pass signals having I components and Q components at predetermined frequencies from the multipliers 212-0, 212-1, . . . , 212-n, respectively.

Further, also the transmission side digital directivity controller 220 comprises in routes correspondingly to the above, and each route comprises: totally n+1 (in this embodiment, n=6) coefficient multipliers 221a0, 221a1, . . . , 221an configured to weight signals combined through the BPFs 211a0, 211b0, 211a1, 211b1, . . . 211an, and 211bn, for obtaining a predetermined transmission directivity exemplarily based on corresponding coefficients (phase control signals) C10, C11, . . . , C1n from the whole controller 201, respectively; and an adder 222 configured to combine outputs from the n+1 coefficient multipliers 221a0 to an. The output from the applicable adder 222 of each route is supplied to the active antenna element P0 of the associated antenna 101, through the associated D/A converter 232 and RF circuit 290.

Also the frequency converter 300 comprises m routes identically to the above, and each route comprises: totally n+1 (in this embodiment, n=6) pairs of coefficient multipliers 261a, 261b, each pair configured to multiply an I component and a Q component of a complex number included in a received signal weighted and then outputted from the associated A/D converter 241, by digital signal bit sequences which are mutually orthogonal, respectively, thereby conducting I-Q orthogonal demodulation (orthogonal detection); and FIR filters 262 configured to combine outputs from the n+1 pairs of coefficient multipliers 261a, 261b to thereby conduct predetermined filtering, respectively.

Identically to the above, the receipt side digital directivity controller 250 comprises in routes correspondingly to the number m (in this embodiment, m=6) antennas 101, and each route comprises: totally n+1 (in this embodiment, n=6) coefficient multipliers 251-0, 251-1, . . . , 251-n configured to weight signals outputted from the FIR filters 262, for obtaining a predetermined receipt directivity exemplarily based on corresponding coefficients (phase control signals) D10, D11, . . . , D1n from the whole controller 201, respectively; and an adder 252 configured to combine outputs from the n+1 coefficient multipliers 251-0, . . . , 251-n.

The receipt side signal processor 260 is connected with error detectors (such as CRC detectors) not shown (in a manner to be connected to the adders 252, for example), and the error state monitoring circuit 204 outputs a selection command signal to the selection circuit 270, depending on error detection signals supplied from the error detectors of the receipt side signal processor 260 (note that the error state monitoring circuit 204 is also configured to output a monitoring result as information in a form of an error flag, for example, to the whole controller 201). This selection command signal is to instruct to select an output of that one of the routes which has outputted a normal detection result in the associated error detector, and the selection circuit 270 selects that one of signals of the routes which corresponds to the selection command signal and the selection circuit 270 outputs the selected signal to the decoder 271.

In this way, the outputs from the adders 252 of the respective routes are subjected to selection at the selection circuit 270 through the receipt side signal processor 260, and the selected signal is decoded at the decoder 271, interpreted at the response bit string interpreter 272, and then taken out as receipt information at the response bit string interpreter 272. As a result, after communications with a communication mate such as another wireless communication apparatus 301 or the like, the whole controller 201 is allowed to obtain information as to what kind of communications the communication mate requests to the wireless communication apparatus 1 in the present embodiment, i.e., to obtain information: about the number of antennas (elements) of the other wireless communication apparatus 301; about applications of the mating user (i.e., as to which of image, voice, text only file, and mail the communication contents are, for example); and as to what degrees the communication mate requests, in terms of data transference time, real-time characteristic, electric-power, user's requested priority level, and the like.

Note that each route of the receipt side signal processor 260 is provided with a RSSI (received signal strength indicator) circuit 260A (conceptually shown in FIG. 4 only), and a detection signal “RSSI” of the RSSI circuit 260A is configured to be inputted into the whole controller 201 as received signal strength (receiving electric field strength) information.

Further, previously stored and maintained in the correlation storage 206 is a correlation between: positional information about countries, districts, and other geographic situations/classifications; and information about maximum communication coverages to be kept (i.e., allowed) based on the laws, regulations, ordinances, and the like to be applied in the geographic situations/classifications, respectively. Note that this correlation may be later subjected to addition, correction, overwriting, and the like, by a manipulation input by an appropriate operator through manipulation means (not shown). Alternatively, it is also possible to allow such addition and the like in a manual or automatic manner through an appropriate network or the like. The whole controller 201 is configured to access to the correlation storage 206 upon input of positional information from the GPS through the input controller 205, and to be allowed to obtain the maximum communication coverage information (limitation value of communication coverage) corresponding to the positional information.

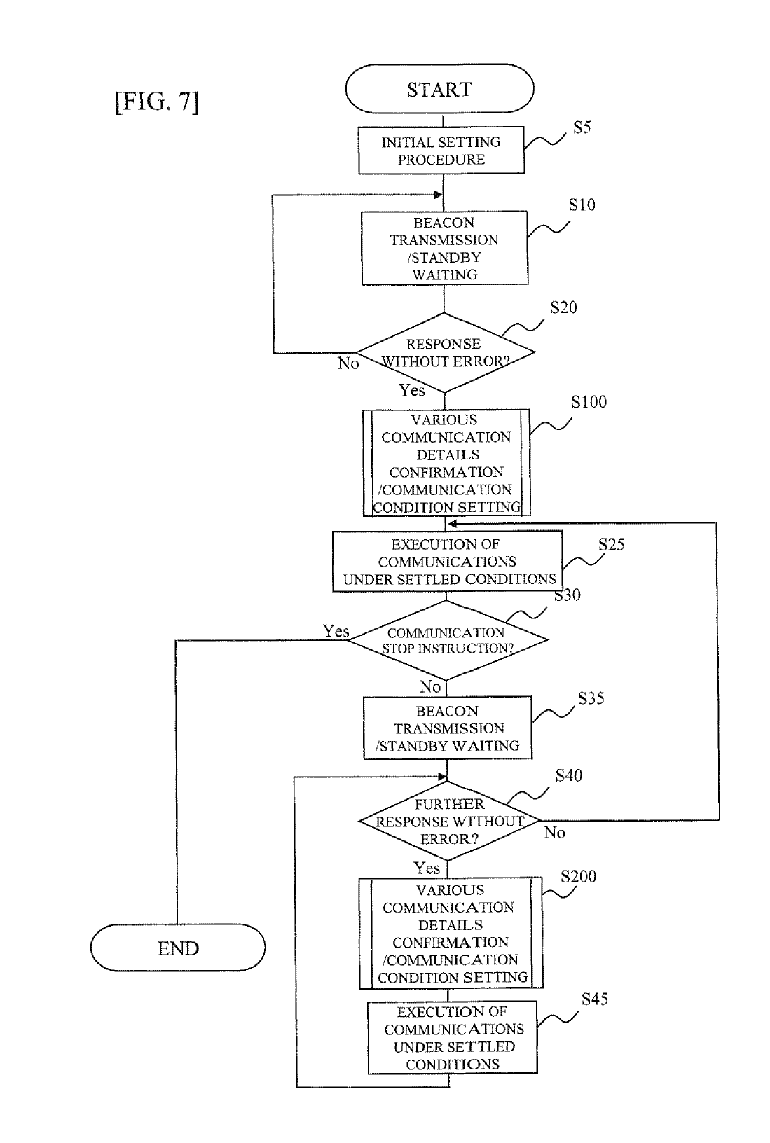

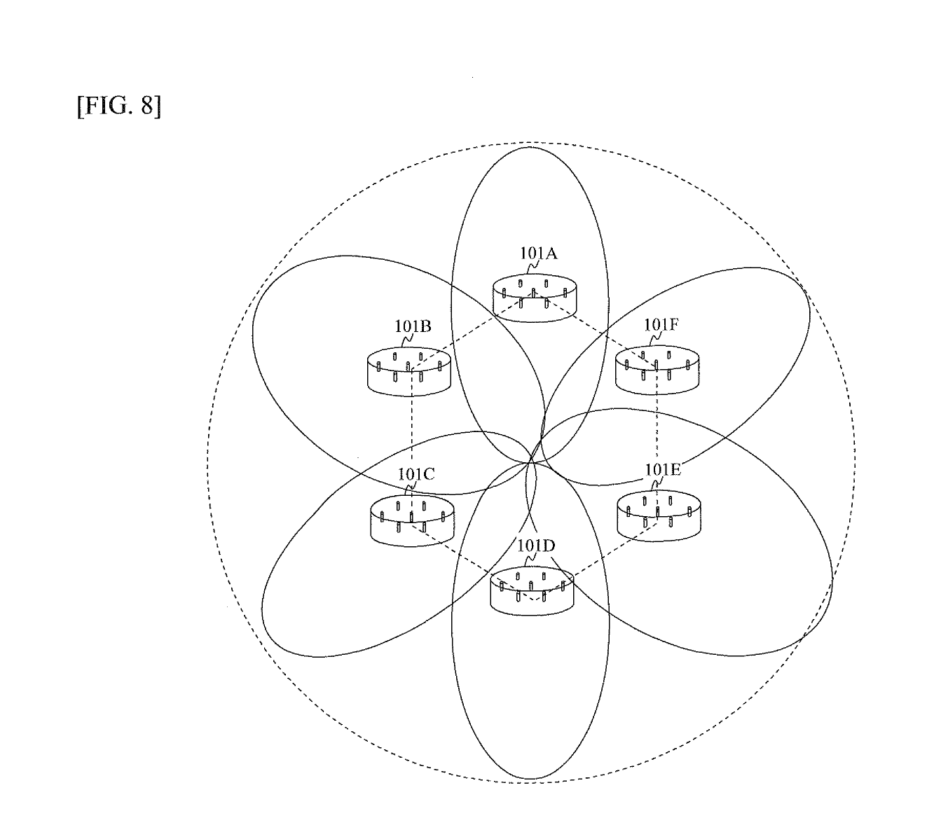

FIG. 7 is a flowchart of a controlling process to be executed by the whole controller 201 provided in the wireless communication apparatus 1 in the present embodiment. In FIG. 7, there is firstly conducted an initial setting procedure at step S5, such that the total directivity based on all the (in this embodiment, six) antennas 101 becomes substantially non-directional. Concretely, the initial setting control is conducted in a manner: to exemplarily output a control signal to the analog directivity controller 280, thereby setting directivities to be provided by passive antenna elements P1 to P6 of all the (in this embodiment, six) antennas 101 to certain predetermined values (predetermined directions) (see FIG. 8 to be described later); and to set the above-mentioned control coefficients D10 to Dmn to the receipt side digital directivity controller 250 and the above-mentioned control coefficients C10 to Cmn to the transmission side digital directivity controller 220, at predetermined values, respectively, such that the total directivity based on all the antenna 101 is made substantially non-directional in substantially all the directions, i.e., is made substantially omnidirectional. At this time, the setting control is conducted in a manner that directivities (extents) of adjacent antennas 101 are overlapped with each other, respectively (see FIG. 8 to be described later). Note that the initial setting values may be configured to be adjusted by an operator in an appropriate manner (or upon shipment from factory).

Thereafter, the flow advances to step S10, where the command bit sequence generator 274, encoder 273, transmission side signal processor 210, frequency converter 310, and transmission side digital directivity controller 220 are duly controlled under the initial setting provided at step S5, in a manner to transmit a beacon signal from the antennas 101 and to subsequently await in a standby state. FIG. 8 is a schematic explanatory view of a radiowave irradiation form in the standby awaiting state after the initial setting. As described above, directivities (extents) of adjacent antennas 101 are overlapped with each other, respectively.

Then, at step S20, there is received a response signal from a communication mate such as another wireless communication apparatus 301, in response to the beacon signal, at the frequency converter 300, receipt side digital directivity controller 250, and receipt side signal processor 260, and it is judged whether or not the response signal has been received without errors at the response bit string interpreter 272 through the selection circuit 270 and decoder 271. When response signals have not been received at all or errors have been caused even upon receipt of a response signal (this state is sensed by an error flag from the error state monitoring circuit 204, for example), the judgment is disaffirmed, so that the flow goes back to step S10 to subsequently continue the standby state.

When a response signal from another wireless communication apparatus 301 or the like is received without errors, the judgment at step S20 is affirmed, and the flow advances to step S100. At step S100, there are conducted: confirmation of communication details to the other wireless communication apparatus 301 (confirmation of various information including the number of antenna elements of the wireless communication apparatus 301, a transmission rate requested thereby, a receiving strength, and the like); and a communication condition setting procedure at the wireless communication apparatus 1 side, corresponding thereto; based on the interpretation result (receipt result) of the received response signal.

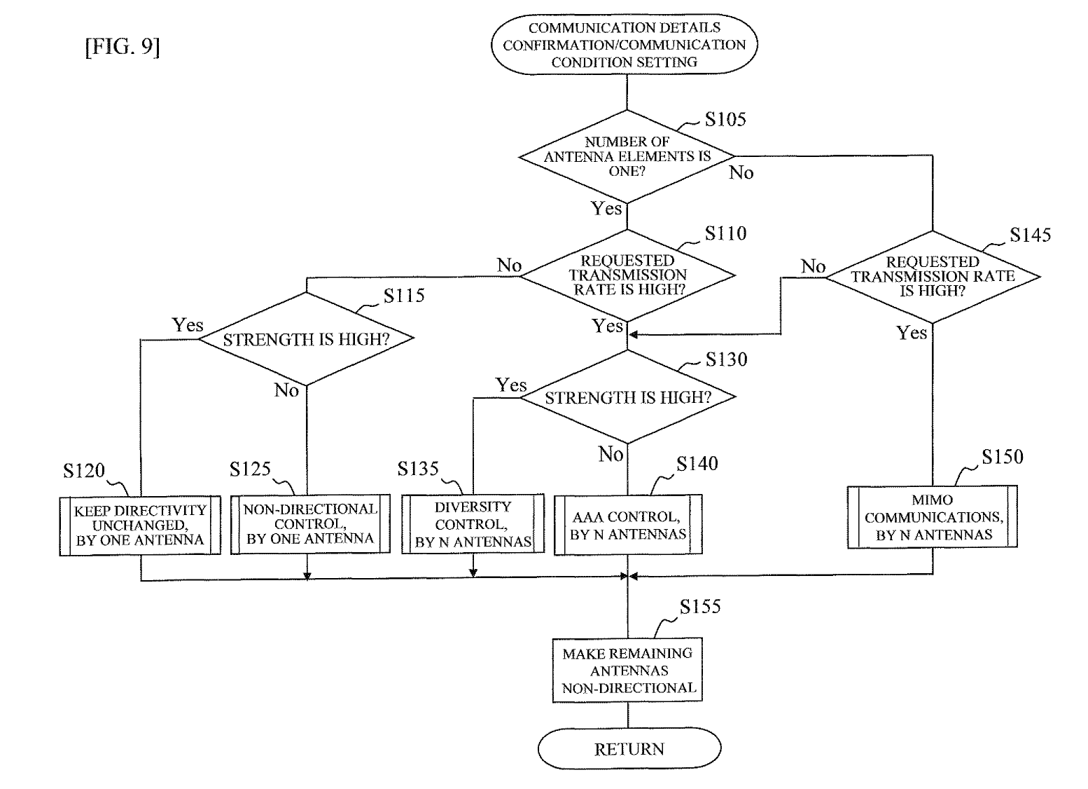

FIG. 9 is a flowchart of a detailed procedure at step S100. At step S105, it is firstly judged whether or not the number of antenna elements of the other wireless communication apparatus 301 or the like is 1, based on the receipt result of the response signal. The judgment is affirmed when the other wireless communication apparatus 301 has not two or more antenna elements but has only one antenna element, and the flow advances to step S110.

At step S110, it is judged whether or not the transmission rate (transmission speed) requested by the other wireless communication apparatus 301 is relatively high, based on the receipt result (it is possible to compare the requested transmission rate with a predetermined threshold rate, for example). When the requested transmission rate is relatively low, the judgment is disaffirmed, and the flow advances to step S115.

At step S115, it is judged whether or not at least one of received signal strengths (detected by the applicable RSSI circuit 260A) upon receipt of the response signal from the other wireless communication apparatus 301 is relatively high, based on the receipt result (it is possible to compare each received signal strength with a predetermined threshold value, for example). When at least one of the received signal strengths is relatively high, the judgment is affirmed and the flow advances to step S120, where control signals are outputted to pertinent components of the wireless transmission apparatus so as to continuously conduct communications with the other wireless communication apparatus 301, in a manner to exemplarily adopt that one of the m (in this embodiment, m=6) antennas 101 which one exhibits the maximum received signal strength (alternatively, it is possible to adopt the antenna exhibiting the minimum error rate) while maintaining the directivity (set in a predetermined direction at step S5) of the adopted antenna 101. At this time, there is further conducted comparative judgment whether or not a spread of a communication coverage to be settled then is within a range of a limitation value of communication coverage based on the positional information inputted from the GPS, and there is conducted appropriate correction as required (to be detailed later). In turn, when the received signal strengths are relatively small, the judgment is disaffirmed and the flow advances to step S125, where control signals are outputted to the transmission side digital directivity controller 220, receipt side digital directivity controller 250, analog directivity controller 280, and the like, so as to conduct communications with the other wireless communication apparatus 301, in a manner to exemplarily adopt that one of the in (in this embodiment, m=6) antennas 101 which one exhibits the maximum received signal strength (alternatively, it is possible to adopt the antenna exhibiting the minimum error rate) while making the directivity (set in a predetermined direction at step S5) of the adopted antenna 101 to be substantially non-directional in substantially all the directions, i.e., to be substantially omnidirectional. Also at this time, there are further conducted comparison with the limitation value of communication coverage, and appropriate correction (to be detailed later), similarly to the above.

Meanwhile, when the transmission rate (transmission speed) requested from the other wireless communication apparatus 301 has been judged to be relatively high at step S110, the judgment is affirmed and the flow advances to step S130. At step S130, identically to step S115, it is judged whether or not at least one of received signal strengths upon receipt of the response signal from the other wireless communication apparatus 301 is relatively high. When at least one of the received signal strengths is relatively high, the judgment is affirmed and the flow advances to step S135, where control signals are outputted to pertinent components of the wireless transmission apparatus so as to conduct a known diversity control by exemplarily adopting N (N≦m) antennas 101 among the m (in this embodiment, m=6) antennas 101 in a predetermined manner (those antennas having higher received signal strengths or smaller error rates can be adopted, for example). In turn, when the received signal strengths are relatively small, the judgment at step S130 is disaffirmed and the flow advances to step S140, where control signals are outputted to the transmission side digital directivity controller 220, receipt side digital directivity controller 250, analog directivity controller 280, and the like, so as to conduct a known adaptive array control by exemplarily adopting N (N≦m) antennas 101 among the m (in this embodiment, m=6) antennas 101 in a predetermined manner (those antennas having higher received signal strengths or smaller error rates can be adopted, for example). Also at step S135 and step S140, there are further conducted comparison with the limitation value of communication coverage, and appropriate correction (to be detailed later), similarly to the above.

Meanwhile, when the number of antenna elements of the other wireless communication apparatus 301 as the communication mate is judged to be two or more at step S105, the judgment is disaffirmed and the flow advances to step S145. At step S145, identically to step S110, it is judged whether or not the transmission rate (transmission speed) requested by the other wireless communication apparatus 301 is relatively high, based on the receipt result. When the requested transmission rate is relatively low, the judgment is disaffirmed, and the flow advances to step S130, followed by the same subsequent procedures as the above. When the requested transmission rate is relatively high, the flow advances to step S150, where control signals are outputted to the transmission side digital directivity controller 220, receipt side digital directivity controller 250, analog directivity controller 280, and the like, so as to conduct communications in a known multiple input and output (MIMO) scheme by exemplarily adopting N (N≦m) antennas 101 among the m (in this embodiment, m=6) antennas 101 in a predetermined manner (those antennas having higher received signal strengths or smaller error rates can be adopted, for example). Also at this time, there are further conducted comparison with the limitation value of communication coverage, and appropriate correction (to be detailed later), similarly to the above.

Note that the above description has been exemplarily provided for a situation where communication conditions are variously settled based on the numbers of antenna elements, magnitudes of requested transmission rates, and magnitudes of received signal strengths, the present invention is not limited thereto, and it is possible to settle the communication conditions based on other information obtainable from a received signal: about applications of a mating user (i.e., as to which of image, voice, text only file, and mail the communication contents are, for example); and as to what degrees the communication mate requests, in terms of data transference time, real-time characteristic, electric-power, user's requested priority level, and the like; for example.

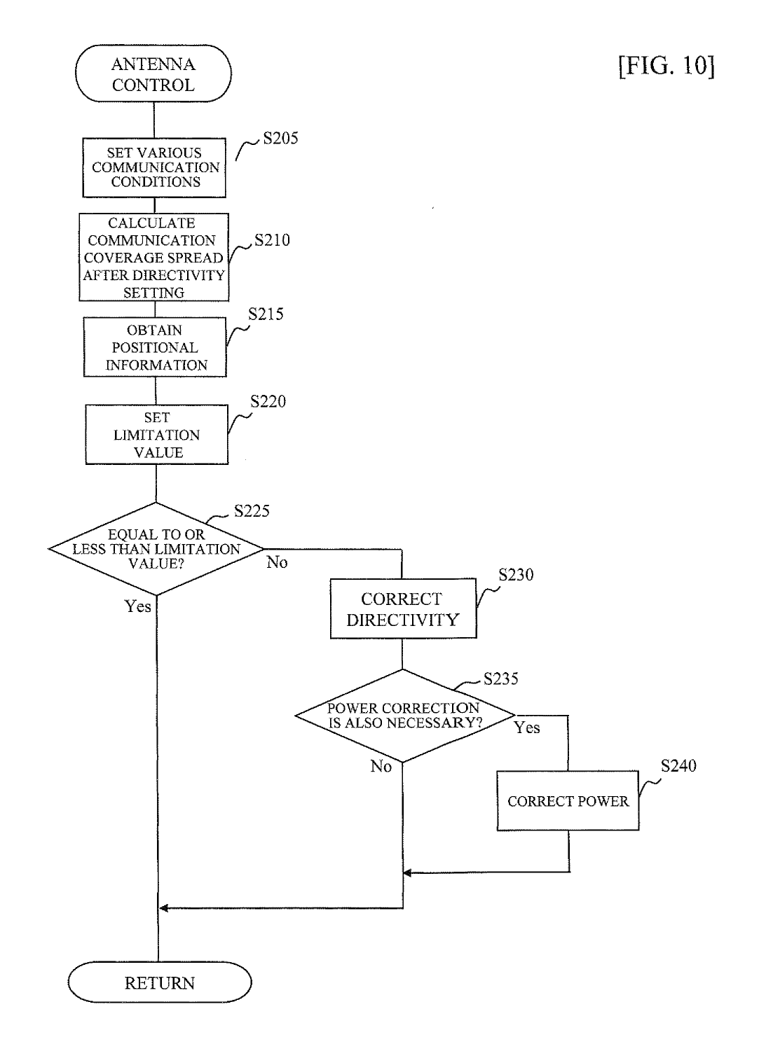

FIG. 10 is a flowchart of a detailed procedure at each of step S120, step S125, step S135, step S140, and step S150. At step S205, there are firstly settled various communication conditions corresponding to respective steps (such as the number of antennas; presence or absence of directivity or variation thereof; presence or absence of application of diversity control, adaptive array control, MIMO communications; transmission output; receive gain; and the like).

Thereafter, the flow advances to step S210, where there is calculated a communication coverage spread (such as a cross-sectional area in a horizontal plane) in the setting based on various conditions (at least including directivity) settled at step S205.

At step S215, there is obtained positional information of the wireless communication apparatus 1 from the GPS through the input controller 205. Thereafter, the flow advances to step S220, where there is accessed to the correlation storage 206 based on the positional information obtained at step S215, to obtain the above-described maximum communication coverage information (limitation value of communication coverage) corresponding to the positional information, and to once store and settle the communication coverage limitation value in an appropriate location (RAM or the like).

Thereafter, the flow advances to step S225, to judge whether or not the communication coverage based on the various communication condition settings (at present) calculated at step S210 is equal to or less than the communication coverage limitation value settled correspondingly to the positional information at step S220.

When the calculated communication coverage is larger than the limitation value, judgment at step S225 is disaffirmed and the flow advances to step S230. At step S230 there are corrected the settings (the above-mentioned control coefficients D10 to Dmn, control coefficients C10 to Cmn, or the like) of the control signals to the analog directivity controller 280, receipt side digital directivity controller 250, and transmission side digital directivity controller 220 so that the calculated communication coverage is made equal to the communication coverage limitation value (or smaller than the communication coverage limitation value), thereby correcting the directivity.

Thereafter, the flow advances to step S235, where it is judged whether or not correction of the transmission output (power) is required, in addition to the correction of the directivity. Concretely, it is judged whether or not simple correction of the directivity fails to make the communication coverage to be smaller than the communication coverage limitation value (or leads to difficulty in achievement thereof), or whether or not combined achievement of directivity correction and correction of transmission output enables the communication coverage to become smaller than the limitation value in an easier or smoother manner. When correction of transmission output is unrequired, the judgment at step S235 is disaffirmed, and this routine is terminated. When correction of transmission output is required, the flow advances to step S240, where there are corrected those control signals (into lowering directions, for example) to variable amplifiers (not shown) provided in the transmission side digital directivity controller 220, D/A converters 232, RF circuits 290, or the like (or provided in the control device 200, separately from these variable amplifiers), and then this routine is terminated.

In turn, when the spread of the communication coverage calculated at step S210 is equal to or less than the communication coverage limitation value settled at step S220, the judgment at step S225 is affirmed and this routine is terminated. Note that, when the calculated spread of communication coverage is equal to or less than the communication coverage limitation value, it is possible to control the directivity based on multiple antenna elements P0 to P6 of the antennas 101A to 101F so that the spread of communication coverage is brought to be a value near the limitation value.

Turning back to FIG. 9, after termination of procedures at step S120, step S125, step S135, step S140, and step S150 in the above manner, the flow advances to step S155, where there is conducted the procedure similar to that at step S5, such that the total directivity based on the remaining antennas 101 of the m antennas 101 other than the antennas 101 to be used at step S120, step S125, step S135, step S140, and step S150, is made substantially non-directional. Note that it is possible to stop communicative operations by the remaining antennas 101. Upon completion of step S155, this routine is terminated.

Turning back to FIG. 7, upon termination of step S100 in the above manner, the flow advances to step S25, where the command bit sequence generator 274, encoder 273, transmission side signal processor 210, frequency converter 310, and transmission side digital directivity controller 220 are controlled under the communication condition settings previously described at step S100, thereby transmitting a signal from the antennas 101 to initiate communications with the other wireless communication apparatus 301.

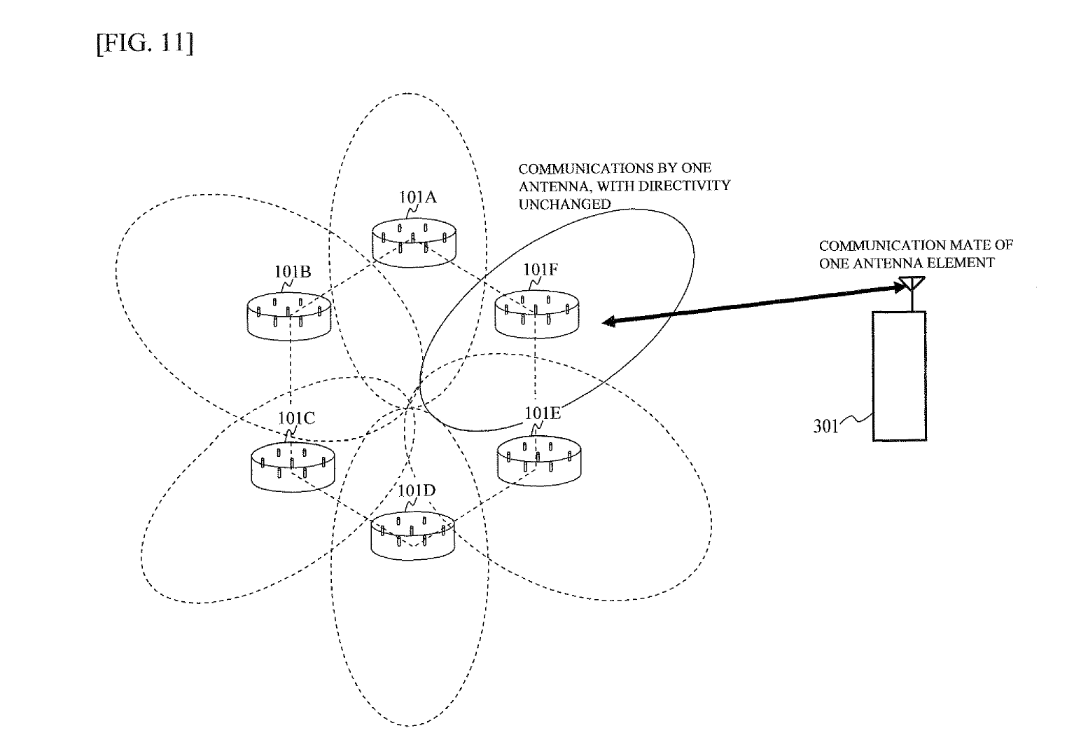

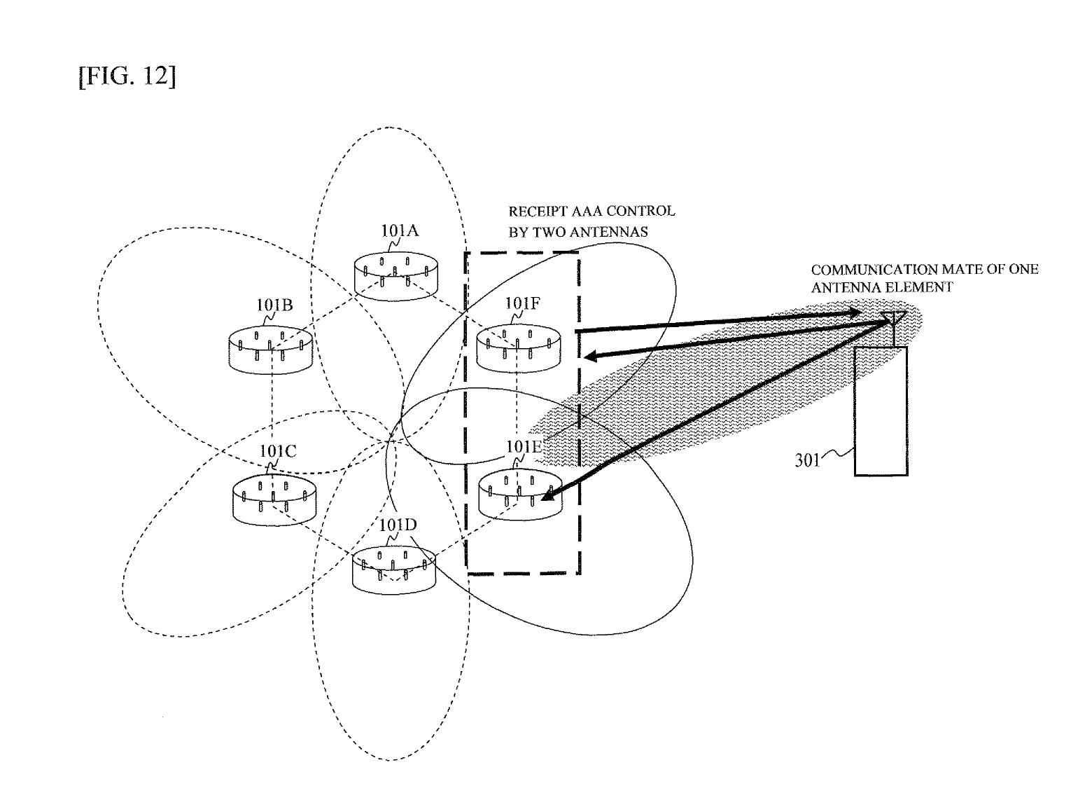

FIG. 11 and FIG. 12 are schematic explanatory views of schemes to be executed at this time for communicating with the other wireless communication apparatus 301. FIG. 11 shows an exemplary state where the setting has been conducted at step S120 because the number of antenna elements of the other wireless communication apparatus 301 is one, the transmission rate requested thereby is low, and the received signal strength is high; and as a result, communications with the other wireless communication apparatus 301 are continuously conducted, while keeping the directivity (settled in the predetermined direction, at step S5) attributed to the applicable one antenna 101.

In turn, FIG. 12 shows an exemplary state where the setting has been conducted at step S140 because the number of antenna elements of the other wireless communication apparatus 301 is one, the transmission rate requested thereby is high, and the received signal strength is small; and as a result, communications are conducted, while utilizing adaptive array control of the N (in this example, N=2) antennas 101E, 101F to maximize a (transmission or receipt) sensitivity to the other wireless communication apparatus 301.

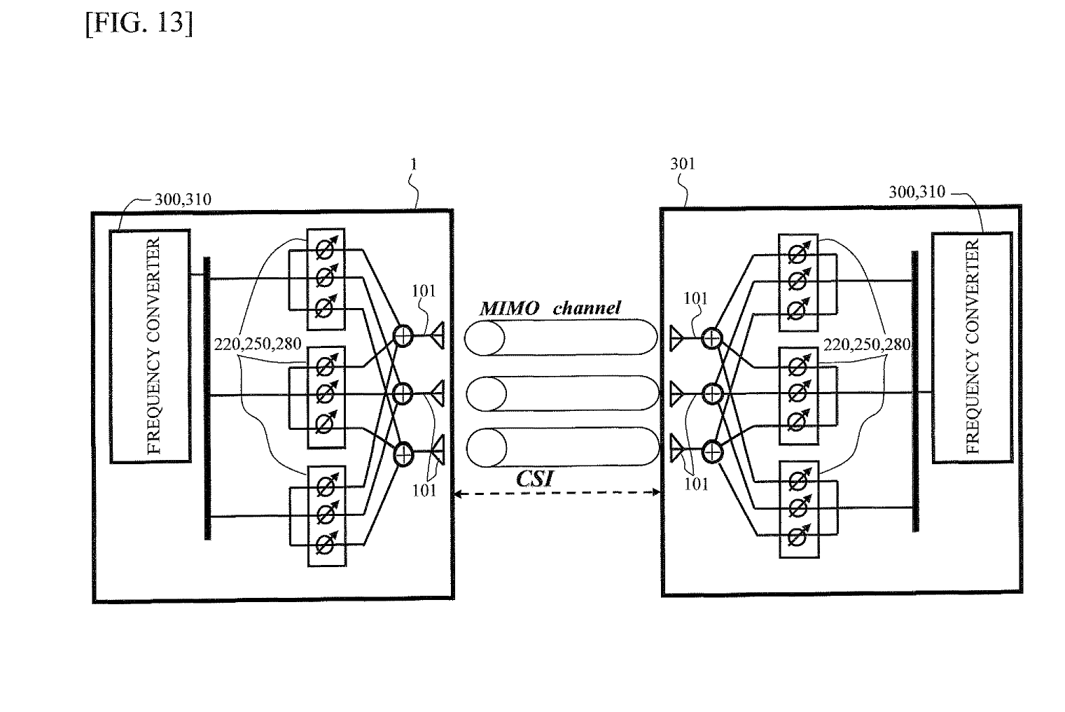

Meanwhile, when the number of antenna elements of the other wireless communication apparatus 301 is two or more and the requested transmission rate is high, there are conducted MIMO communications utilizing the N antennas 101 at step S150, and FIG. 13 is a conceptional explanatory view of a behavior in the MIMO communications. Note that, for clarification of depiction, this figure shows the concept in a manner that the number of antennas 101 of the wireless communication apparatus 1 in the present embodiment is three, and that the other wireless communication apparatus 301 as the communication mate also has the same configuration as the wireless communication apparatus 1 in the present embodiment. As shown, in case of conduction of communications between the three transmission antennas 101 of the wireless communication apparatus 1 and the three receipt antennas 101 of the other wireless communication apparatus 301, channel responses between transmission and receipt are represented by a 3×3 matrix. In this case, the shown 3×3=9 transmission paths (channels) can be virtually converted into three independent channels by virtue of eigenvalue transformation in the MIMO communications under a multipath environment, thereby enabling an improved utilization of space.

Turning back to FIG. 7, upon termination of step S25 in the above manner, the flow advances to step S30, where it is judged whether or not a communication stop instruction from an operator is present. This judgment is affirmed when the wireless communication stop instruction has been given by the operator or the like through manipulation means (not shown) provided in the wireless communication apparatus 1, and then the flow is terminated. This judgment is disaffirmed until a stop instruction is given, so that the flow advances to step S35.

At step S35, the apparatus transmits a beacon signal and enters a standby awaiting state, identically to step S10. At this time, the one to N antennas adopted at step S120, step S125, step S135, step S140, and step S150 have been already used for communications with the other wireless communication apparatus 301, so that it is enough to transmit the beacon signal by adopting only one of the remaining antennas 101 other than the already adopted ones.

Thereafter, the flow advances to step S40, where it is judged, similarly to step S20, whether or not a communication mate such as still another wireless communication apparatus 302 has appeared in response to the beacon signal, and if appeared, whether or not the response signal therefrom has been received by the frequency converter 300, receipt side digital directivity controller 250, and receipt side signal processor 260, and then received by the response bit string interpreter 272 without errors through the selection circuit 270 and decoder 271. The judgment is disaffirmed when response signals have not been received at all, or errors have occurred even in case of receipt of a response signal, so that the flow goes back to step S25 to repeat the same procedures.

In turn, the judgment at step S40 is affirmed when a response signal from the still other wireless communication apparatus 302 has been received without errors, so that the flow advances to step S200. At step S200, there is conducted a procedure identical to that at step S100, in a manner to conduct confirmation (confirmation of the number of antenna elements, the requested transmission rate, and various information about the receiving strength and the like) based on the interpretation result (receipt result) of the received response signal, and there is conducted a communication condition setting procedure corresponding to the above at the side of the wireless communication apparatus 1. The detailed explanation thereof shall be omitted, because the depiction of FIG. 11 is enough therefor, similarly to step S100.

Upon completion of step S200, the flow advances to step S45, to control, in a manner similar to step S25, the command bit sequence generator 274, encoder 273, transmission side signal processor 210, frequency converter 310, and transmission side digital directivity controller 220 to thereby transmit a signal from the antennas 101 under the communication condition settings previously described for step S200, thereby starting communications with the still other wireless communication apparatus 302.

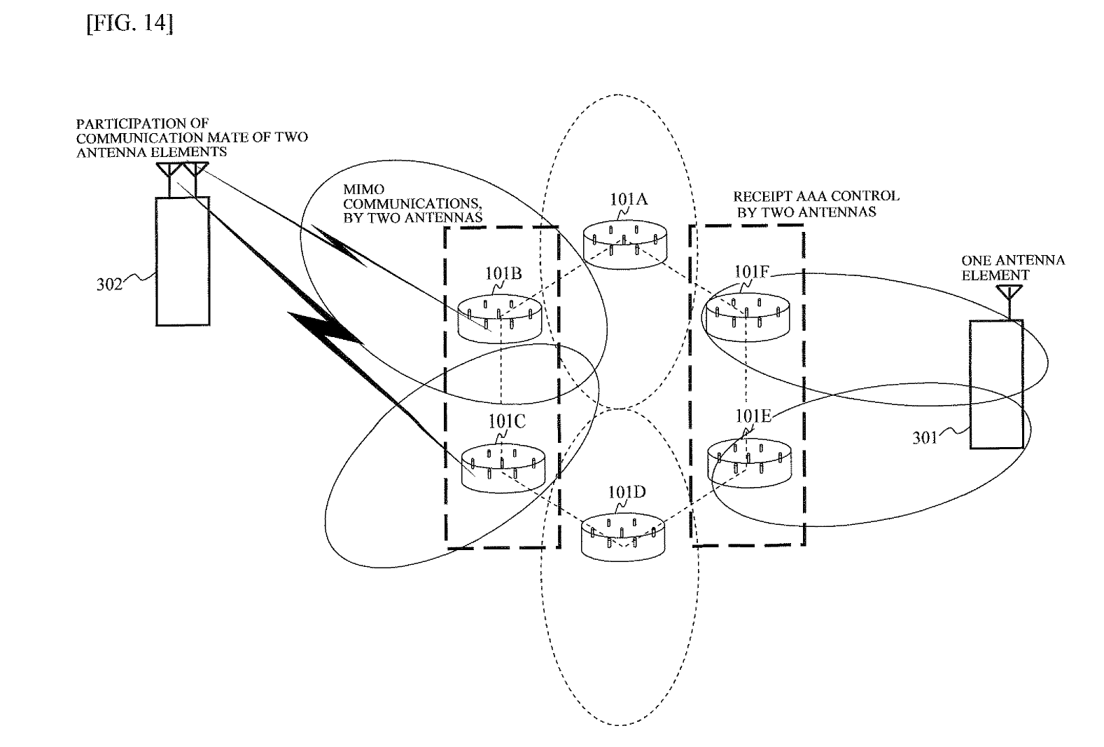

FIG. 14 is a schematic explanatory view of a scheme to be executed at this time for communicating with the still other wireless communication apparatus 302. FIG. 14 shows an exemplary state that: the still other wireless communication apparatus 302 has appeared when communications with the other wireless communication apparatus 301 having one antenna element have been already conducted by means of the antennas 101E, 101F; and the number of antenna elements of the still other wireless communication apparatus 302 is two and the requested transmission rate is high; so that the setting has been conducted at step S150 of FIG. 9, thereby resulting in starting of communications with the still other wireless communication apparatus 302 in the MIMO scheme by adopting antennas 101B, 101C (selected as the antenna having the maximum receipt power and the antenna having the next maximum, from among the antennas 101A, 101B, 101C, 101D out of communications then).

Turning back to FIG. 7, upon termination of step S45 as described above, the flow goes back to step S40 to repeat the same procedures.

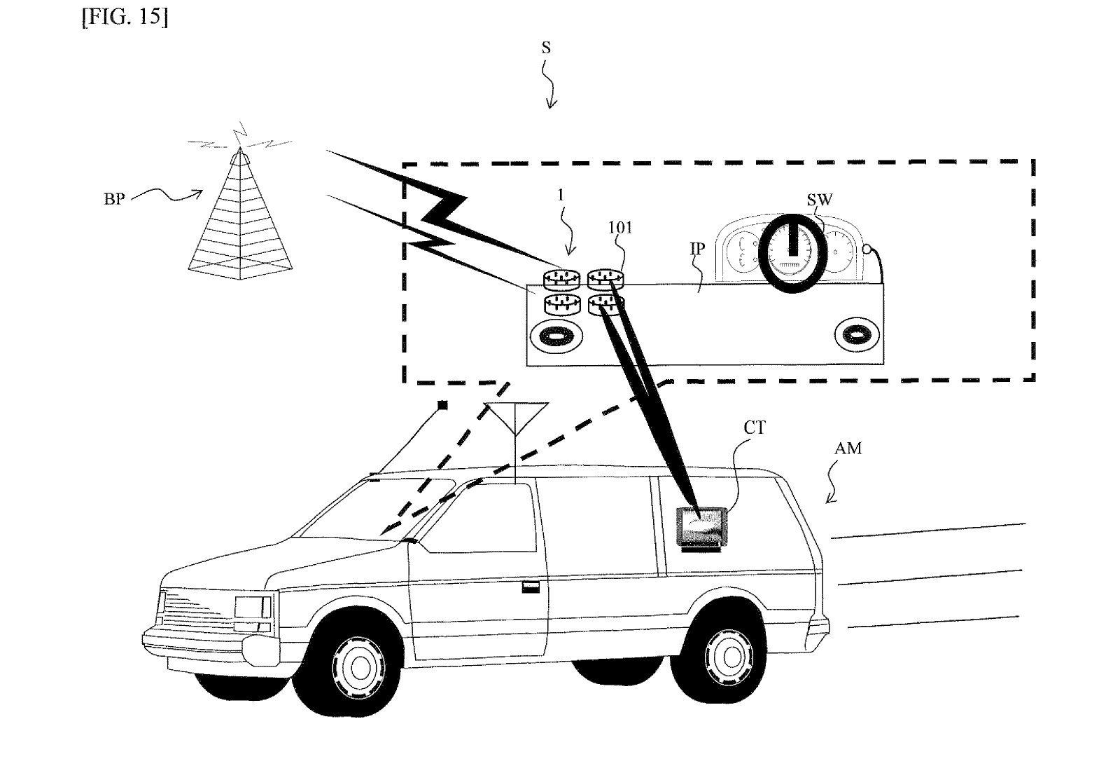

FIG. 15 is a schematic view of an actual application example of the wireless communication apparatus 1 in the present embodiment having the above-described configuration. The example of FIG. 15 is provided with: the wireless communication apparatus 1 provided on an inner panel IP located at the front of a compartment and at a side (assistant driver's seat side) opposite to a steering wheel SW; and a television set CT (corresponding to the other wireless communication apparatus 301 or the like) located at the back of the compartment (at a rear seat side) and having an antenna (not shown). Then, communications are being conducted between multiple antennas 101 of the wireless communication apparatus 1 and the television set CT, and between other multiple antennas 101 and a base station BP (which corresponds to the other wireless communication apparatus 301 or the like, or may be an artificial satellite or the like) at a ground side. At this time, the wireless communication apparatus 1 is functioning as a wireless transmission apparatus or wireless receipt apparatus, and these wireless communication apparatuses 1, 301, and 301 configures the wireless communication system S.

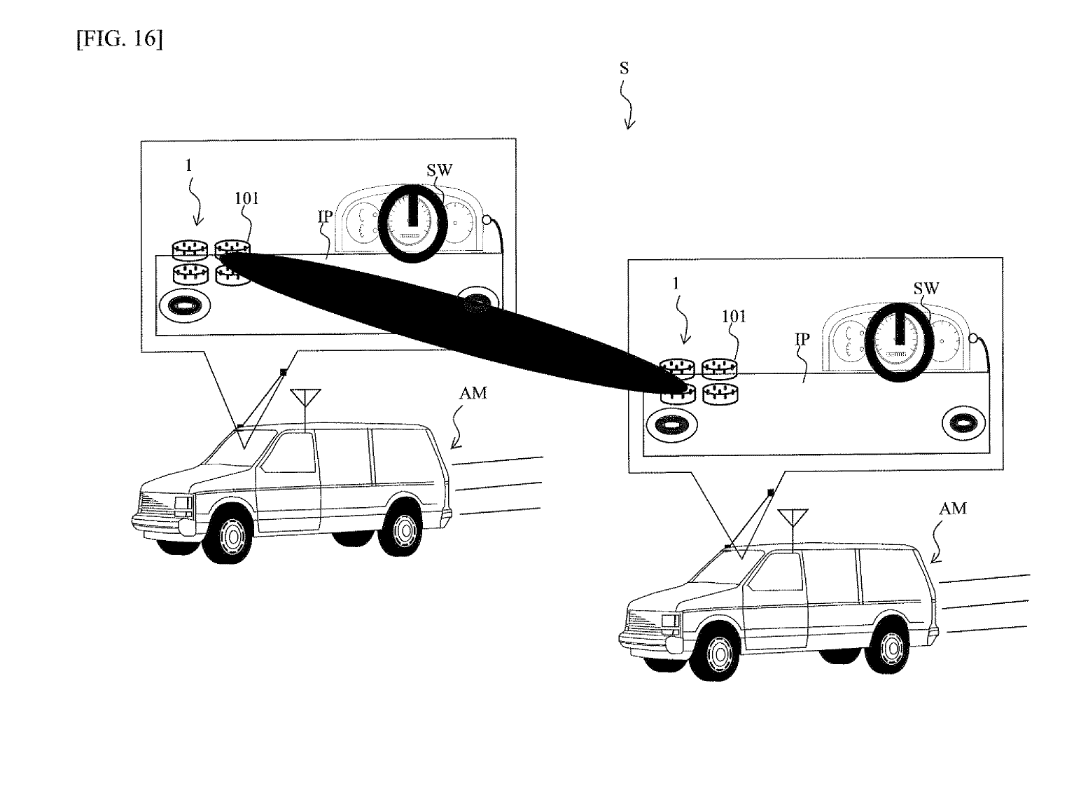

FIG. 16 is a schematic view of another actual application example of the wireless communication apparatus 1 in the present embodiment. In this example of FIG. 16, wireless communication apparatuses 1 are provided on inner panels IP of two automobiles AM, AM in the same manner as FIG. 15. Further, communications (so-called intervehicular communications) are being conducted between the two wireless communication apparatuses 1, 1 by multiple antennas 101, for example. In this case, if based on one of the wireless communication apparatuses 1, the other wireless communication apparatus 1 corresponds to the above described other wireless communication apparatus 301, and these wireless communication apparatuses 1, 301 constitute the wireless communication system S. Further, the wireless communication apparatus 1 is functioning as a wireless transmission apparatus or wireless receipt apparatus.

In the above, the whole of the multiple antennas 101 (101A to 101F in the above embodiment) constitutes the antennas comprising multiple antenna elements recited in claims. Further, the receipt side digital directivity controller 250, transmission side digital directivity controller 220, and analog directivity controller 280 provided in the control device 200 constitute the directivity controlling unit that controls the directivity based on the multiple antenna elements of the antenna.

Further, the procedure at step S210 of the flowchart shown in FIG. 10 to be executed by the whole controller 201 corresponds to the spread calculation unit that calculates a spread (horizontal cross-sectional area) of communication coverage attained by the antenna having the directivity controlled by the directivity controlling unit, and the procedure at step S220 corresponds to the limitation setting unit sets a communication coverage limitation value corresponding to the positional information based thereon, and the procedure at step S225 corresponds to the comparison unit (or step) that compares the calculated communication coverage spread and the settled communication coverage limitation value. Further, the procedure at step S240 constitutes the radiowave output controlling unit controls a radiowave coverage from the antenna, in cooperation with the directivity controlling unit depending on the comparison result by the comparison unit.

As explained above, the wireless communication apparatus 1 in the present embodiment includes: the (antennas 101A to 101F) having multiple antenna elements P0 to P6; and the directivity controlling unit (the receipt side digital directivity controller 250, transmission side digital directivity controller 220, and analog directivity controller 280, in this embodiment) that controls the directivity based on the multiple antenna elements P0 to P6 of the antennas 101A to 101F; and the wireless transmission apparatus 1 is characterized in that the same further includes: the spread calculation unit (the procedure at step S210 to be executed by the whole controller 201 in this embodiment) that calculates the spread of communication coverage based on the antennas 101A to 101F having the directivity controlled by the directivity controlling unit 220, 250, 280; the limitation setting unit (the procedure at step S220 to be executed by the transmission side signal processor 210) that sets the communication coverage limitation value corresponding to the positional information based thereon; and the comparison unit (the procedure at step S225 to be executed by the whole controller 201) that compares the calculated communication coverage spread with the settled communication coverage limitation value.

In the wireless communication apparatus 1 in the present embodiment, when the directivity based on the multiple antenna elements P0 to P6 of the antennas 101A to 101F is controlled by the directivity controlling unit 220, 250, 280, the communication coverage spread of the antennas 101A to 101F is calculated by the spread calculation unit (or step) S210, and the communication coverage limitation value based on the positional information is set by the limitation setting unit (or step) S220. Further, the comparison unit (or step) S225 compares the communication coverage spread calculated by the spread calculation unit (or step) S210, with the communication coverage limitation value set by the limitation setting unit (or step) S220. In this way, the directivity controlling unit 220, 250, 280 can control the communication coverage spread to be smaller than the applicable limitation value, when the communication coverage spread calculated by the spread calculation unit (or step) S210 is larger than the communication coverage limitation value settled by the limitation setting unit (or step) S220. As a result, it becomes possible to realize a maximum communication coverage within conformable limits to thereby conduct efficient communications, in a manner to conform to limitations to be kept based on the laws, regulations, and the like to be applied in the countries, districts, and other geographic situations/classifications.

The wireless communication apparatus 1 in this embodiment is characterized in that the directivity controlling unit 220, 250, 280 controls the directivity based on the multiple antenna elements P0 to P6 of the antennas 101A to 101F depending on the comparison result by the comparison unit (or step) S225 so that the communication coverage spread becomes equal to or less than the applicable limitation value, when the calculated communication coverage spread exceeds the settled communication coverage limitation value.

Controlling the communication coverage spread to become equal to or less than the limitation value by the directivity controlling unit 220, 250, 280, allows for control in a manner capable of conforming to communication coverage limitations to be kept based on the laws, regulations, and the like to be applied in the countries, districts, and other geographic situations/classifications.

The wireless communication apparatus 1 in the embodiment is characterized in that the directivity controlling unit 220, 250, 280 controls the directivity based on the multiple antenna elements P0 to P6 of the antennas 101A to F depending on the comparison result by the comparison (unit or step) S225 so that the communication coverage spread is brought to be a value near the limitation value, when the calculated communication coverage spread is equal to or less than the settled communication coverage limitation value.

Thus, when the communication coverage calculated by the spread calculation unit (or step) S210 is smaller than the communication coverage limitation value settled by the limitation setting unit (or step) S220, it is possible to control the communication coverage spread to reach the limitation value or a value at least near it by the directivity controlling unit 220, 250, 280, thereby enabling realization of a maximum communication coverage within the limitations in a reliable manner, to thereby conduct effective communications.

The wireless communication apparatus 1 in the present embodiment is characterized by comprising: the radiowave output controlling unit (or step) (the procedure at step S240 to be executed by the whole controller 201) that controls the radiowave coverage from the antennas 101A to 101F, in cooperation with the directivity controlling unit 220, 250, 280 depending on the comparison result by the comparison unit (or step) S225.

Conducting the output control together with the directivity control, enables realization of a maximum communication coverage within limitations to be kept based on laws, regulations, and the like, in a further reliable manner, to thereby conduct effective communications.

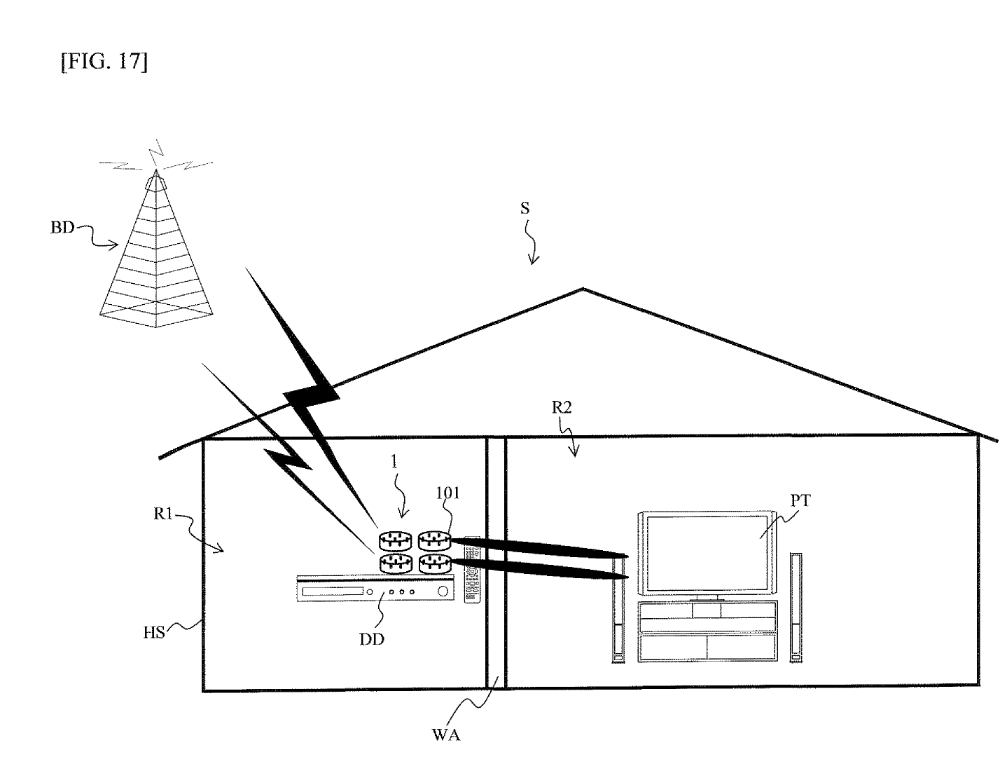

FIG. 17 is an actual example of the wireless communication apparatus 1 capable of obtaining the above effect. In this example of FIG. 17, the wireless communication apparatus 1 is provided on a DVD deck DD arranged in a first room R1 of a house HS, while there is provided a television set PT (corresponding to the above-described other wireless communication apparatus 301 or the like) having an antenna (not shown) in a second room R2 partitioned from the first room R1 through a relatively thick wall WA. Further, communications are being conducted between multiple antennas 101 of the wireless communication apparatus 1 and the television set PT, and between the other multiple antennas 101 and a base station BP (which corresponds to the other wireless communication apparatus 301 or the like, or may be an artificial satellite or the like). At this time, the wireless communication apparatus 1 is functioning as a wireless transmission apparatus or wireless receipt apparatus, and the wireless communication apparatuses 1, 301 constitute the wireless communication system S.

In this case, since the first room R1 and the second room R2 are partitioned from each other by the thick wall WA (thereby conducting so-called through-wall communication), radio waves between the wireless communication apparatus 1 of the DVD deck DD and the television set PT (corresponding to the other wireless communication apparatus 301) are considerable in attenuation, thereby possibly bringing about difficulty in communications. Nonetheless, it is possible to realize reliable and effective communications penetrating through the wall WA, by conducting the output control together with the directivity control in the above manner to increase the output to thereby extend a maximum communication coverage within limitations of communication coverage to be kept based on the laws, regulations, and the like.

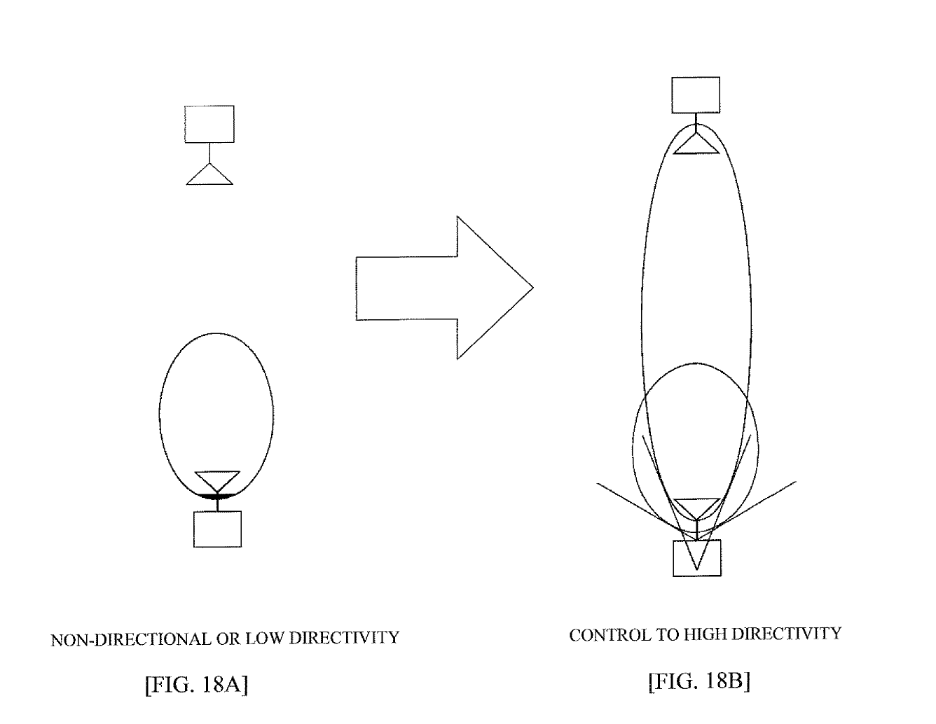

Broadening the above concept, it becomes possible to substantially extend a communication distance, by conducting the output control together with the directivity control in a manlier to realize a maximum communication coverage within limitations of communication coverage to be kept based on the laws, regulations, and the like. FIG. 18 is an explanatory view for concretely explaining an example of such an effect.

FIG. 18 shows a situation where the wireless communication system S of this embodiment is utilized for mitigating an antenna gain condition of a low-powered data communication system (wireless LAN). According to the regulation of the Radio Law presently effective in Japan, wireless LAN is presently allowed to use an antenna gain of (principally) 2.14 dBi at the maximum. As such, when communications are intended in a state that the directivity from the wireless communication apparatus 1 at the transmitting side is substantially non-directional or relatively widely directional, the communication coverage (area) is limited to the limitation value, thereby resulting in a relatively shorter communication distance and failing to cause radio waves to reach a communication mate at a larger distance (see FIG. 18A).

Nonetheless, when the wireless communication apparatus 1 at the transmitting side is caused to relatively narrow its directivity in the above manner, the communication coverage (area) is relatively made narrower, thereby enabling to correspondingly increase the transmission output and to resultingly extend a communication distance. As a result, the communication distance can be extended to three times at the maximum as shown in FIG. 18B, for example, thereby enabling radio waves to reach even the above-described communication mate.

The wireless communication apparatus 1 in the above embodiment is characterized in that the same includes a (correlation storage 206,) that stores and maintains a correlation between positional information and communication coverage limitation values corresponding to the positional information; and the limitation setting unit (or step) S220 sets the communication coverage limitation value based on the correlation maintained in the correlation storage 206.

In this way, the limitation setting unit (or step) S220 can easily set a communication coverage limitation value corresponding to positional information, by causing the correlation storage 206 to refer to the correlational information based on the positional information to thereby obtain the communication coverage limitation value corresponding to the positional information.

The wireless communication apparatus 1 in the above embodiment is characterized in that the limitation setting unit (or step) S220 sets the communication coverage limitation value based on positional information from the global positioning system (GPS).

In this way, whatever position the wireless communication apparatus 1 is located on the globe, the wireless communication apparatus 1 is capable of assuredly obtaining the positional information about the position from the global positioning system (GPS), thereby enabling settlement of the corresponding communication coverage limitation value.

The wireless communication apparatus 1 in the above embodiment is characterized in that the antenna 101 comprises multiple antennas 101A to 101F each including multiple antenna elements P0 to P6, and the antenna 101 is configured to be usable in a wireless communication system S of multiple input and output scheme.

It becomes thus possible to execute a large capacity transmission by multiplex transmission paths or a high efficiency transmission by a single transmission path.

The wireless communication apparatus 1 in the above embodiment is characterized in that the multiple antenna elements P0 to P6 of the antenna 101 includes: an active element P0 fed with a signal; and at least one passive element P1 to P6 provided at a predetermined distance from the active element P0 and fed with no signals; and the active element and the or each passive element are encapsulated or loaded in a dielectric 120 and located at a predetermined distance from each other.

It is possible to obtain a broad band and a high gain characteristic and to downsize the antennas 101, by adopting an Espar antenna, which comprises an active element P0 and passive elements P1 to P6 and which is controllable in directivity by reactance control to the passive elements P1 to P6; and by encapsulating (or loading) the multiple elements P0 to P6 into a dielectric.

The wireless communication apparatus 1 in the above embodiment is characterized in that the directivity controlling unit 220, 250, 280 includes: an active side controlling unit 220, 250 that controls the directivity of the active element P0; and a passive side controlling unit 280 that controls the directional of the or each passive element P1 to P6.

When it is intended to conduct a directivity control of the whole of in antennas 101 by the active elements P0 only of the antennas 101, the number of antennas, the number of RE circuits, and digital processing corresponding thereto are made large-scaled. Contrary, even when it is intended to conduct a directivity control such as adaptive operation control by the passive elements P1 to P6 only of the antennas 101, the digital processing is made large-scaled similarly to the above.

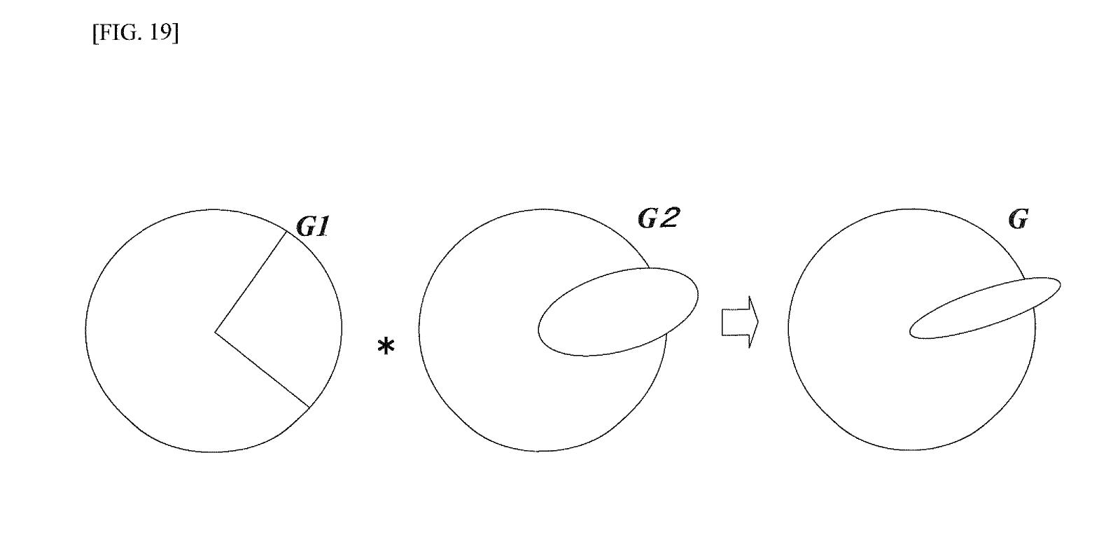

As conceptually represented by an image of directivity control property in FIG. 19, in the wireless communication apparatus 1 in the present embodiment, the directivity is firstly and roughly set by the passive side controlling unit 280 (see region G1), and then finer directivity control is conducted by the active side controlling unit 220, 250 (see region G2), thereby enabling achievement of a sharper directivity by virtue of the thus combined settings (see region G). It is also possible to improve flexibility of the apparatus as a directivity control system.

Note that this embodiment is not limited to the above, and various modifications are possible. Namely, although details have not been particularly explained upon control of MIMO communications at step S150 of the flowchart shown in FIG. 9, it is appropriate to employ a technique of known space-time coding (STC) or space-division multiplexing (SDM) scheme in this MIMO communication control. It is also possible to appropriately and combiningly adopt a known orthogonal frequency division multiplexing (OFDM) technique.

Namely, the communication scheme controlling unit (or step) S100 in the wireless communication apparatus 1 in this case is configured to control the communications scheme to be additionally combined with at least one of the space-time coding or space-division multiplexing, and orthogonal frequency division multiplexing.

Thus, it becomes possible to conduct effective communications with a communication mate in a reliable manner, by exemplarily realizing: control (=space-time coding scheme: STC) to recompose signals of time series data to be transmitted, in a time domain and a space domain; or control (=space-division multiplexing scheme; SDM) to transmit individual information of equal powers, antenna element by antenna element of transmission; and multiple carrier transmission control (=orthogonal frequency division multiplexing scheme; OFDM) to deploy wide frequency band information into many sub-channels of narrow frequency bands.

Further, although the above has been explained for an example adopting the multiple antennas 101A to 101F each having multiple antenna elements P0 to P6, the present invention is not limited thereto, and it is possible to conduct the same control, for multiple antenna elements included in multiple antennas as a whole each including one antenna element, or for multiple antenna elements included in one antenna. The same effect can be obtained in each case.

Furthermore, although the positional information has been obtained from the GPS, the present invention is not limited thereto. Namely, it is possible: to input the location of the wireless communication apparatus 1 by an operator through manipulation means (not shown); or to fetch positional information from a car navigation system other than the GPS, from a monitor/monitoring system having a camera or image processor, or from other various systems. In case of utilizing a car navigation system, it becomes possible to easily operate the wireless communication apparatus in conjunction with an applicable regulation (spread of maximum communication coverage) even when the regulation is changed across a boundary between countries or areas (such as near an astronomical observatory of a national park, in another radiowave restricted region, or the like) during travel of the car. In turn, in case of utilizing a monitor/monitoring system, it becomes possible to easily operate the wireless communication apparatus in conjunction with such an applicable mechanical/structural operation to alter the radiowave environment (such as opening and closing of door, alteration of hermetic property of a space, alteration of radiowave obstacle, or the like), by duly recognizing such an operation.

The wireless communication apparatus 1 in the above embodiment includes: six antennas 101A to 101F each comprising seven antenna elements P0 to P6; and the receipt side digital directivity controller 250, transmission side digital directivity controller 220, and analog directivity controller 280, for controlling the directivity based on the antenna elements P0 to P6 of the antennas 101A to 101F; wherein the wireless communication apparatus 1 includes: the procedure at step S210 for calculating a spread of communication coverage based on the antennas 101A to 101F having the directivity controlled by the receipt side digital directivity controller 250, transmission side digital directivity controller 220, and analog directivity controller 280; the procedure at step S220 for setting a communication coverage limitation value corresponding to the positional information based thereon; and the procedure at step S225 for comparing the calculated communication coverage spread with the settled communication coverage limitation value.

When the directivity based on the antenna elements P0 to P6 of the antennas 101A to 101F is controlled by the receipt side digital directivity controller 250, transmission side digital directivity controller 220, and analog directivity controller 280 of the wireless communication apparatus 1, the communication coverage spread of the antennas 101A to 101F is calculated at step S210, and the communication coverage limitation value is set based on the positional information at step S220. Further, the communication coverage spread calculated at step S210 and the communication coverage limitation value settled at step S220 are compared with each other at step S225. It becomes thus possible that: when the communication coverage spread calculated at step S210 is larger than the communication coverage limitation value settled at step S220, for example, the receipt side digital directivity controller 250, transmission side digital directivity controller 220, and analog directivity controller 280 cooperatively control the communication coverage spread to be equal to or less than the limitation value; and when communication coverage spread calculated at step S210 is smaller than the communication coverage limitation value settled at step S220, the receipt side digital directivity controller 250, transmission side digital directivity controller 220, and analog directivity controller 280 cooperatively control the communication coverage spread to reach the limitation value or a value at least near it. As a result, it becomes possible to realize a maximum communication coverage within conformable limits to thereby conduct efficient communications, in a manner to conform to limitations to be kept based on the laws, regulations, and the like to be applied in the countries, districts, and other geographic situations/classifications.

The wireless communication system S in the above embodiment comprises the wireless transmission apparatus 1 and the other wireless receipt apparatus 301, and is capable of conducting communications in the multiple input and output scheme, wherein the wireless transmission apparatus 1 and the other wireless receipt apparatus 301 each include: six antennas 101A to 101F each comprising seven antenna elements P0 to P6; the receipt side digital directivity controller 250, transmission side digital directivity controller 220, and analog directivity controller 280, for controlling the directivity based on the antenna elements P0 to P6 of the antennas 101A to 101F; the procedure at step S210 for calculating a spread of communication coverage based on the antennas 101A to 101F having the directivity controlled by the receipt side digital directivity controller 250, transmission side digital directivity controller 220, and analog directivity controller 280; the procedure at step S220 for setting a communication coverage limitation value corresponding to the positional information based thereon; and the procedure at step S225 for comparing the calculated communication coverage spread with the settled communication coverage limitation value.

In the wireless communication apparatus 1 or wireless communication apparatus 301 of the wireless communication system S, when the directivity based on the antenna elements P0 to P6 of the antennas 101A to 101F is controlled by the receipt side digital directivity controller 250, transmission side digital directivity controller 220, and analog directivity controller 280, the communication coverage spread of the antennas 101A to 101F is calculated at step S210, and the communication coverage limitation value is set based on the positional information at step S220. Further, the communication coverage spread calculated at step S210 and the communication coverage limitation value settled at step S220 are compared with each other at step S225. It becomes thus possible that: when the communication coverage spread calculated at step S210 is larger than the communication coverage limitation value settled at step S220, for example, the receipt side digital directivity controller 250, transmission side digital directivity controller 220, and analog directivity controller 280 cooperatively control the communication coverage spread to be equal to or less than the limitation value; and when communication coverage spread calculated at step S210 is smaller than the communication coverage limitation value settled at step S220, the receipt side digital directivity controller 250, transmission side digital directivity controller 220, and analog directivity controller 280 cooperatively control the communication coverage spread to reach the limitation value or a value at least near it. As a result, it becomes possible to realize a maximum communication coverage within conformable limits to thereby conduct efficient communications, in a manner to conform to limitations to be kept based on the laws, regulations, and the like to be applied in the countries, districts, and other geographic situations/classifications.

1-10. (canceled)

11. A wireless communication apparatus comprising: an antenna unit comprising multiple antenna elements; and a directivity controlling unit controls directivity based on said multiple antenna elements of said antenna unit; wherein said wireless communication apparatus further comprises:
a spread calculation unit that calculates a spread of the communication coverage based on said antenna unit having the directivity controlled by said directivity controlling unit;
a limitation setting unit that sets a communication coverage limitation value corresponding to positional information based thereon; and
a comparison unit that compares the calculated communication coverage spread with the settled communication coverage limitation value; and
said directivity controlling unit controls the directivity based on said multiple antenna elements of said antenna unit depending on the comparison result by said comparison unit so that the communication coverage spread becomes equal to or less than the applicable limitation value, when the calculated communication coverage spread exceeds the settled communication coverage limitation value.

12. A wireless communication apparatus comprising: an antenna unit comprising multiple antenna elements; and a directivity controlling unit controls directivity based on said multiple antenna elements of said antenna unit; wherein said wireless communication apparatus further comprises:
a spread calculation unit that calculates a spread of the communication coverage based on said antenna unit having the directivity controlled by said directivity controlling unit;
a limitation setting unit that sets a communication coverage limitation value corresponding to positional information based thereon; and
a comparison unit that compares the calculated communication coverage spread with the settled communication coverage limitation value; and
that said directivity controlling unit controls the directivity based on said multiple antenna elements of said antenna unit depending on the comparison result by said comparison unit so that the communication coverage spread is brought to be a value near the limitation value, when the calculated communication coverage spread is equal to or less than the settled communication coverage limitation value.

13. The wireless communication apparatus according to claim 11, wherein
said wireless communication apparatus further comprises a radiowave output controlling unit controls the radiowave coverage from said antenna unit, in cooperation with said directivity controlling unit depending on the comparison result by said comparison unit.

14. The wireless communication apparatus according to claim 11, wherein
said wireless communication apparatus further comprises a storage unit that stores and maintains a correlation between positional information and communication coverage limitation values corresponding to said positional information; and
said limitation setting unit sets the communication coverage limitation value based on the correlation maintained in said storage unit.

15. The wireless communication apparatus according to claim 11, wherein
said limitation setting unit sets the communication coverage limitation value based on positional information from a global positioning system.

16. The wireless communication apparatus according to claim 11, wherein
said antenna unit comprises multiple antennas each including multiple antenna elements, and said antenna unit is configured to be usable in a wireless communication system of a multiple input multiple output scheme.

17. The wireless communication apparatus according to claim 11, wherein
said multiple antenna elements of said antenna unit includes:
an active element fed with a signal; and at least one passive element provided at a predetermined distance from said active element and fed with no signals; and
said active element and the or each passive element are encapsulated or loaded in a dielectric and located at a predetermined distance from each other.

18. The wireless communication apparatus according to claim 17, wherein
said directivity controlling unit includes: an active side controlling unit controls the directivity of said active element; and a passive side controlling unit that controls directivity of the or each passive element.

19. A wireless communication system comprising a wireless transmission apparatus and a wireless receipt apparatus, and being capable of conducting communications in a multiple input multiple output scheme, wherein at least one of said wireless transmission apparatus and said wireless receipt apparatus comprises:
an antenna unit comprising multiple antenna elements;
a directivity controlling unit that controls directivity based on said multiple antenna elements of said antenna unit;
a spread calculation unit that calculates a spread of communication coverage based on said antenna unit having the directivity controlled by said directivity controlling unit;
a limitation setting unit that sets a communication coverage limitation value corresponding to the positional information based thereon; and
a comparison unit that compares the calculated communication coverage spread with the settled communication coverage limitation value; and
said directivity controlling unit controls the directivity based on said multiple antenna elements of said antenna unit depending on the comparison result by said comparison unit so that the communication coverage spread becomes equal to or less than the applicable limitation value, when the calculated communication coverage spread exceeds the settled communication coverage limitation value.

20. A wireless communication system comprising a wireless transmission apparatus and a wireless receipt apparatus, and being capable of conducting communications in a multiple input multiple output scheme, wherein at least one of said wireless transmission apparatus and said wireless receipt apparatus comprises:
an antenna unit comprising multiple antenna elements;
a directivity controlling unit that controls directivity based on said multiple antenna elements of said antenna unit;
a spread calculation unit that calculates a spread of communication coverage based on said antenna unit having the directivity controlled by said directivity controlling unit;
a limitation setting unit that sets a communication coverage limitation value corresponding to the positional information based thereon; and
a comparison unit that compares the calculated communication coverage spread with the settled communication coverage limitation value; and
that said directivity controlling unit controls the directivity based on said multiple antenna elements of said antenna unit depending on the comparison result by said comparison unit so that the communication coverage spread is brought to be a value near the limitation value, when the calculated communication coverage spread is equal to or less than the settled communication coverage limitation value.
